(19) United States
(12) Patent Application Publication
(10) Pub. No.: US 2026/0289165 A1
(43) Pub. Date: Sep. 24, 2026

(54) SYSTEM

(71) Applicant: SoftBank Group Corp., Tokyo (JP)

(72) Inventor: Masaki HAMADA, Tokyo (JP)

(73) Assignee: SoftBank Group Corp., Tokyo (JP)

(21) Appl. No.: 19/562,892

(22) Filed: Mar. 11, 2026

(30) Foreign Application Priority Data
Mar. 19, 2025 (JP) 2025-044971

(51) Int. Cl. G06F 40/40; G06F 40/174; G06F 40/205; G06F 40/30; G06V 10/72; G06V 10/774; G06V 40/16; G10L 21/0208; G10L 25/63

(52) U.S. Cl. CPC G06F 40/40; G06F 40/174; G06F 40/205; G06F 40/30; G06V 10/72; G06V 10/774; G06V 40/174; G10L 21/0208; G10L 25/63

(57) ABSTRACT

A system includes a processor that is configured to acquire sound, motion, and environmental information of animals and plants, perform preprocessing on the acquired information to convert the acquired information into an analyzable format, analyze a prompt that instructs estimation of a state of the animals and plants from a user, estimate the state of the animals and plants by using a generative artificial intelligence model based on the prompt and the analyzable format, and generate an answer based on the estimated state.

### CROSS-REFERENCE TO RELATED APPLICATION

This application is based on and claims priority under 35 USC 119 from Japanese Patent Application No. 2025-044971 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional technologies for observing animals and plants are mainly limited to simple monitoring of sounds, movements, or environmental conditions, and do not provide a mechanism for semantically inferring internal states of animals and plants in a manner understandable to a user. In particular, existing systems generally rely on fixed rule-based thresholds or manually designed indicators, which cannot flexibly interpret complex and context-dependent relationships between multimodal sensor data and the actual condition of living entities. As a result, a user cannot easily obtain high-level, human-readable explanations such as whether an animal or plant is hungry, stressed, comfortable, or in another state, especially on a continuous and autonomous basis.

Moreover, conventional communication-support systems for patients in a vegetative state often require highly specialized equipment and manual interpretation by medical experts, and do not make use of generative artificial intelligence models to provide user-oriented, conversational outputs derived from biosignals such as brain waves and other physiological signals. Therefore, there is a need for a unified system that acquires multimodal information from animals and plants, preprocesses and analyzes the information with artificial intelligence, interprets user prompts, and generates explanatory answers, while also enabling communication-like interaction with persons in a vegetative state based on analysis of their brain waves and biosignals, and that further operates continuously over long periods through neural network-based learning.

### SUMMARY

In order to solve the above-described problems, an embodiment of the invention provides a system comprising a processor, wherein the processor is configured to acquire sound, motion, and environmental information of animals and plants; perform preprocessing on the acquired information to convert the acquired information into an analyzable format; analyze a prompt that instructs estimation of a state of the animals and plants from a user; estimate the state of the animals and plants by using a generative artificial intelligence model based on the prompt and the analyzable format; and generate an answer based on the estimated state. In addition, the processor is configured to analyze brain waves and biosignals of a person in a vegetative state and enable communication with the person based on a result of the analysis, thereby allowing the system to output user-understandable information regarding the person's condition. Furthermore, the processor is configured to continuously collect, twenty-four hours a day and three hundred sixty-five days a year, the sound, motion, and environmental information of the animals and plants, and perform learning by using a neural network based on the continuously collected information, so that the estimation accuracy and expressive capability of the generative artificial intelligence model are improved over time and the system can adapt to individual differences and temporal changes in the states of animals, plants, and persons in a vegetative state.

The term “system” refers to an integrated combination of hardware and software components including at least one processor, memory, and input/output interfaces, configured to execute the functions defined in the claims.

The term “processor” refers to any hardware device or combination of hardware devices capable of executing instructions, including but not limited to a central processing unit (CPU), a graphics processing unit (GPU), a digital signal processor (DSP), a microcontroller, or a plurality of such units operating in cooperation.

The term “animals and plants” refers to living biological organisms including non-human animals and plants that emit sound, exhibit motion, or are affected by environmental conditions that can be sensed and analyzed by the system.

The term “sound, motion, and environmental information of animals and plants” refers to data obtained from sensors, including audio signals representing vocalizations or other sounds, image or video data representing movements or postures, and measurements of surrounding environmental conditions such as temperature, humidity, illumination, or other physical quantities associated with the living environment of animals and plants.

The term “acquire” refers to detecting, receiving, or collecting information from one or more sensors or external devices and storing the information in a memory accessible by the processor.

The term “preprocessing” refers to one or more operations applied to raw acquired information to convert the information into an analyzable format, such operations including, but not limited to, filtering, noise reduction, normalization, feature extraction, encoding, compression, or formatting.

The term “analyzable format” refers to a representation of the acquired information, such as feature vectors, structured data, tensors, or other machine-readable formats, which is suitable for input to a machine learning model or other analytical algorithm.

The term “prompt” refers to an input provided by a user, in natural language or in another representation, that instructs or requests the system to estimate or infer a state of animals and plants or a state of a person in a vegetative state.

The term “analyze a prompt” refers to processing the prompt by parsing, interpreting, or otherwise transforming the prompt to extract an intent, a query, or parameters that are used by the generative artificial intelligence model to perform state estimation and answer generation.

The term “state of the animals and plants” refers to an internal or external condition associated with animals and plants, including but not limited to hunger, thirst, stress, comfort, activity level, health condition, or other physical or emotional states that can be inferred from sensor data.

The term “generative artificial intelligence model” refers to a machine learning model that is configured to generate outputs, such as textual descriptions, inferred labels, or other data, based on input data and learned parameters, and that may include, for example, a neural network, a large language model, a variational autoencoder, a generative adversarial network, or other generative architectures.

The term “estimate the state” refers to inferring, predicting, or classifying a probable condition or label representing the state of animals and plants or of a person in a vegetative state, based on the analyzable format of the acquired information and, where applicable, the content of the prompt.

The term “answer” refers to an output generated by the system, including a natural-language response, a symbolic label, a numerical score, or a combination thereof, that conveys information about an estimated state to the user in a human-understandable form.

The term “person in a vegetative state” refers to a human subject who exhibits wakefulness without detectable awareness according to medical criteria, and who may be unable to communicate voluntarily by conventional behavioral means.

The term “brain waves and biosignals” refers to physiological signals acquired from a human subject, including but not limited to electroencephalogram (EEG) signals, heart rate, electrocardiogram (ECG), respiration, blood oxygen saturation, skin conductance, or other measurable physiological parameters.

The term “enable communication” refers to providing information to a user that reflects an estimated state, response, or condition of a person in a vegetative state, derived from analysis of brain waves and biosignals, such that the user can interpret the information as a form of indirect or mediated interaction with the person.

The term “continuously collect, twenty-four hours a day and three hundred sixty-five days a year” refers to acquiring information from sensors in an ongoing manner without intentional long interruptions, while allowing for practical constraints such as brief maintenance, calibration, or failure-recovery periods.

The term “neural network” refers to a machine learning model composed of layers of interconnected nodes or neurons that process input data to learn mappings between inputs and outputs, and that may include architectures such as feedforward networks, convolutional neural networks, recurrent neural networks, transformer networks, or combinations thereof.

The term “perform learning by using a neural network” refers to adjusting parameters of a neural network, such as weights and biases, based on the continuously collected information, by applying training or fine-tuning procedures so that the neural network improves its performance in estimating states or generating answers over time.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

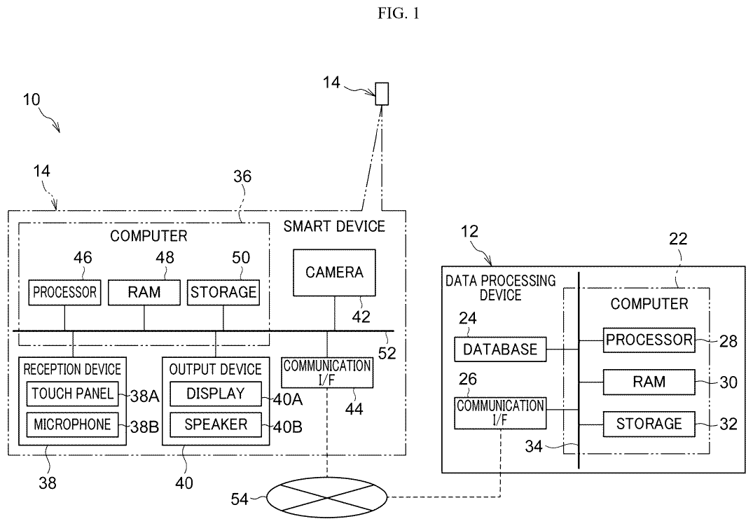

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

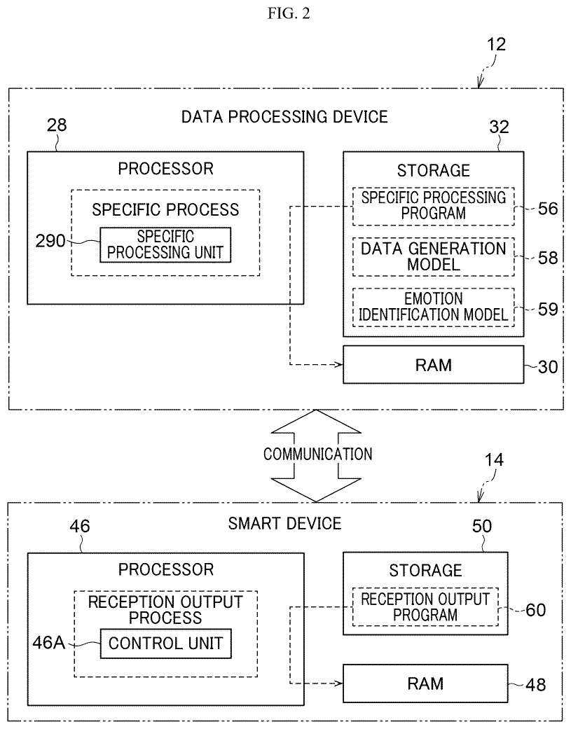

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer systems that attempt to interpret behaviors of organisms such as animals, plants, or unconscious patients generally rely on fixed rule sets, static classifiers, or isolated machine learning models that are trained for narrow tasks. Such systems typically process sound data, image data, or environmental data in a siloed manner, without integrating these heterogeneous data streams into a unified representation that can be robustly consumed by higher-level reasoning components. As a result, these systems often fail to produce stable, context-aware inferences about internal states or intentions of the organisms, particularly when environmental conditions change or when long-term behavioral patterns must be considered.

In addition, in conventional architectures, user interaction is usually limited to simple query interfaces that directly trigger a classification or retrieval operation. A user's natural-language question regarding the state of an organism is not systematically converted into a structured, machine-interpretable request that is aligned with the internal representation used by the underlying models. Consequently, generative artificial intelligence models, when used, are often fed with ad hoc or incomplete context, which leads to non-deterministic, inconsistent, or technically ungrounded responses. This diminishes the reliability and technical usefulness of generative models in tasks that require consistent mapping between sensor data, inferred internal states, and natural-language explanations.

Moreover, existing systems generally do not maintain an explicit, machine-readable language system that encodes a correspondence between learned behavior patterns and semantic state labels. Without such a language system that is dynamically constructed and updated from the output of time-series analysis models, the system cannot systematically refine its mappings or expose them as structured knowledge. This prevents the computer system from improving its own interpretability and reproducibility over time, and limits its capacity to provide stable, explainable responses across repeated user queries.

From a computer technology perspective, these limitations manifest as architectural shortcomings: (i) the absence of a standardized pipeline that converts raw multimodal sensor streams into unified feature sequences suitable for time-series pattern analysis; (ii) the lack of an integrated mechanism that builds and updates a language system as a structured knowledge layer above the learned patterns; and (iii) the absence of a controlled procedure that converts user prompt sentences and internal analysis results into composite prompts for a generative AI model. These shortcomings result in inefficient use of computational resources, difficulties in scaling to multiple organisms and long-term monitoring, and poor coupling between data processing modules and generative models.

Therefore, there is a need for an improved computer-implemented system and method that (1) continuously acquires and preprocesses multimodal data from organisms in a uniform, model-ready format; (2) performs time-series analysis to identify behavior patterns and constructs a machine-readable language system mapping those patterns to internal state representations; and (3) transforms user prompt sentences and internal system context into composite prompts for a generative AI model, thereby enabling the model to generate technically grounded, context-consistent natural-language answers. Such a system should enhance the functioning of the computer itself by defining specific data structures, processing flows, and model interfaces that improve robustness, scalability, and interpretability of organism-state inference.

The specific processing by the specific processing unit 290 of the data processing device 12 in Example 1 is realized by the following means.

The present invention provides a server comprising a processor and a memory storing instructions that, when executed by the processor, cause the processor to perform operations including: acquiring sound information, image information, and environmental information related to an organism from an input apparatus including an imaging apparatus and an acoustic collection apparatus, on a continuous or periodic basis; preprocessing the sound information and the image information to generate standardized feature sequences representing behavior of the organism, the preprocessing including sampling, normalization, noise reduction, and frequency-domain conversion for the sound information, and decoding, resolution conversion, color-space conversion, and background separation for the image information; inputting the feature sequences into an identification model including a machine learning model for time-series data analysis, and classifying or clustering behavior patterns of the organism based on the feature sequences; constructing and updating, in a storage unit, language system information that encodes correspondence relationships between the behavior patterns and state information indicative of internal states or intentions of the organism; receiving, from a user terminal, a prompt sentence including an interrogative sentence regarding a state of the organism, and parsing the prompt sentence to extract at least a target, a time range, and a question intention; acquiring, from the storage unit, one or more behavior patterns and corresponding portions of the language system information that match the extracted target and time range; generating context information describing a current or past state of the target based on the acquired behavior patterns and the language system information; generating a composite prompt sentence by combining the context information with the prompt sentence according to a predetermined prompt template; and inputting the composite prompt sentence into a generative artificial intelligence model to cause the generative artificial intelligence model to estimate the state of the organism based on the language system information and to generate an answer sentence in natural language including a result of the estimation, and outputting the generated answer sentence to the user terminal. This enables a technical improvement in computer processing for organism-state inference by defining a specialized data acquisition and preprocessing pipeline, a structured language system layer linking time-series behavior patterns to semantic state labels, and a controlled composite-prompt generation mechanism that tightly couples internal model outputs with generative AI responses, thereby producing more robust, context-consistent, and explainable natural-language answers than conventional systems.

The term “organism” refers to any living biological entity, including an animal, a plant, or a human, whose behavior or internal state is to be monitored or inferred by the system.

The term “sound information” refers to digital data representing acoustic signals associated with an organism or its surrounding environment, including but not limited to vocalizations, movement sounds, and ambient noises, which are captured by an acoustic collection apparatus.

The term “image information” refers to digital data representing two-dimensional or multi-frame visual observations of an organism or its surrounding environment, including still images and video frames, which are captured by an imaging apparatus.

The term “environmental information” refers to digital data representing physical conditions around an organism, including at least one of temperature, humidity, illumination, motion, and other measurable environmental parameters, which are acquired by one or more environmental sensors.

The term “input apparatus” refers to a hardware configuration including at least an imaging apparatus and an acoustic collection apparatus, and optionally one or more environmental sensors, which provides sound information, image information, and environmental information to the server.

The term “imaging apparatus” refers to a device that captures visual data of an organism or its environment and outputs corresponding digital image information, such as a camera or image sensor.

The term “acoustic collection apparatus” refers to a device that captures acoustic signals in the vicinity of an organism and outputs corresponding digital sound information, such as a microphone or audio sensor.

The term “time information” refers to data indicative of a time at which sound information, image information, or environmental information was acquired, including timestamps or time indices used to align and correlate multiple data streams.

The term “target identification information” refers to data that uniquely or specifically associates acquired information with a particular organism or monitoring subject, such as an identifier, label, or index used by the system.

The term “preprocessing” refers to a series of computational operations applied to raw sound information and image information to convert the raw data into standardized, model-ready feature representations, including operations such as sampling, normalization, noise reduction, decoding, resolution conversion, color-space conversion, and background separation.

The term “sampling” refers to the process of converting continuous-time sound information into discrete-time digital samples at a defined sampling rate suitable for subsequent analysis.

The term “normalization” refers to the process of adjusting numerical ranges or distributions of sound information or image information, such as scaling amplitudes or pixel values, to a standardized range to stabilize model training or inference.

The term “noise reduction” refers to the process of suppressing or removing unwanted components from sound information or image information, such as background noise or artifacts, using digital filtering or other signal processing techniques.

The term “frequency-domain representation” refers to a representation of sound information obtained by transforming time-domain signals into the frequency domain, for example through a spectral transform, resulting in data that expresses energy or amplitude as a function of frequency and time.

The term “two-dimensional numerical array” refers to a data structure with at least two indices, such as time and frequency, which stores numerical values derived from processed sound information and is suitable for input to a machine learning model.

The term “time-series image sequence” refers to a temporally ordered collection of image frames derived from image information, representing the evolution of visual observations of an organism over time.

The term “feature sequence” refers to a sequence of numerical feature vectors or tensors derived from sound information, image information, or both, which characterizes behavioral aspects of an organism as a function of time and is suitable for time-series analysis.

The term “identification model” refers to a computational model, including at least one machine learning model, that receives a feature sequence and performs classification, clustering, or other pattern recognition to identify behavior patterns or state patterns of an organism.

The term “machine learning model for time-series data analysis” refers to a model architecture, such as a recurrent model, a convolutional model, or a transformer-based model, that is designed to process temporally ordered feature sequences and to learn temporal dependencies or patterns from such sequences.

The term “behavior pattern” refers to a characteristic temporal pattern or configuration of features extracted from one or more data streams associated with an organism, which reflects recurring behaviors or reactions of the organism.

The term “state information” refers to data indicative of an internal state, condition, or intention of an organism, such as stress, comfort, alertness, need for water, or similar states, which is associated with one or more behavior patterns.

The term “language system information” refers to structured data stored in a storage unit that encodes correspondence relationships between behavior patterns and state information, and optionally includes semantic labels, rules, and examples used to interpret and describe organism states in natural language.

The term “storage unit” refers to any memory or storage device, such as a volatile or non-volatile memory, a database, or a storage subsystem, used to store language system information, feature sequences, model outputs, or other data required by the system.

The term “user terminal” refers to an external computing device operated by a user, such as a smartphone, tablet, personal computer, or similar device, that communicates with the server, transmits prompt sentences, and receives answer sentences.

The term “prompt sentence” refers to natural-language text provided by a user via the user terminal, including at least one interrogative sentence regarding a state of an organism, and serving as input for further processing by the server and a generative artificial intelligence model.

The term “target” refers to an organism or monitored subject specified or implied in a prompt sentence, for which a state is to be inferred and explained.

The term “time range” refers to a temporal interval, specified or inferred from a prompt sentence, that defines which portion of stored behavior patterns or analysis results is relevant to respond to the prompt sentence.

The term “question intention” refers to an extracted representation of the purpose or focus of a prompt sentence, such as an inquiry about a cause, a current state, a comparison, or a recommendation, which guides how the system generates an answer.

The term “context information” refers to a synthesized, machine-generated description of a current or past state of a target, derived from behavior patterns and language system information, and used as part of a composite prompt for a generative artificial intelligence model.

The term “composite prompt sentence” refers to a combined text input for a generative artificial intelligence model that includes at least context information generated by the system and a prompt sentence provided by a user, arranged according to a predetermined template.

The term “prompt template” refers to a predefined textual and structural pattern that specifies how context information, language system information, and a prompt sentence are arranged or formatted to form a composite prompt sentence for a generative artificial intelligence model.

The term “generative artificial intelligence model” refers to a model that generates natural-language text or other content in response to an input prompt, by learning patterns from data, and that is capable of producing answer sentences that interpret organism states based on context information and language system information.

The term “answer sentence” refers to a natural-language output generated by a generative artificial intelligence model, which includes at least a result of an estimation of a state of an organism and which is provided to a user via the user terminal.

The term “unconscious person” refers to a human individual in a condition where voluntary communication is impaired or absent, such as a comatose or minimally responsive state, and whose brain wave information and biometric signal information are analyzed by the system.

The term “brain wave information” refers to digital data representing electrical activity of a brain of a person, acquired from one or more brain signal acquisition devices and used as a source for time-series feature extraction.

The term “biometric signal information” refers to digital data representing physiological signals of a person, including at least heart rate, respiration, muscle activity, or similar parameters, which are acquired from biometric sensors and used as sources for time-series feature extraction.

The term “state pattern” refers to a pattern in time-series feature data derived from brain wave information or biometric signal information, which is associated with a particular internal condition or response of an unconscious person.

The term “meaning information enabling communication” refers to semantic data associated with a state pattern that allows the system to interpret the pattern as conveying a communicable meaning, such as comfort, discomfort, or response to a stimulus, usable in generating natural-language explanations.

The term “latest analysis result” refers to a most recent set of outputs from the identification model or related processing, including inferred behavior patterns, state information, and associated confidence measures, used when generating a composite prompt sentence.

In one embodiment, server implements the claimed system as a network-connected computing apparatus including at least one processor, a main memory, a non-volatile storage device, a network interface, and, optionally, a graphics processing unit (GPU). Server executes an operating system such as a general-purpose server operating system and runs an application program that implements the acquisition, preprocessing, analysis, language system construction, prompt handling, and response generation described below. Server stores executable instructions and configuration data in the non-volatile storage device and loads them into the main memory during operation.

Server connects to one or more input apparatuses deployed near organisms. The input apparatuses include at least one imaging apparatus, such as a digital video camera, and at least one acoustic collection apparatus, such as a digital microphone. In some implementations, the input apparatuses further include environmental sensors, such as temperature sensors, humidity sensors, light sensors, and motion sensors. Server communicates with these input apparatuses via a wired or wireless network using standardized protocols, for example, real-time streaming protocols for video and audio streams and sensor communication protocols for environmental information.

Server associates each input apparatus with a target identification information entry. For example, server maintains a configuration table in a database system, mapping a unique target identifier to a set of device identifiers and location information. Server uses this configuration to interpret incoming data streams as belonging to specific organisms, such as a particular plant in a pot, a specific bird observed by a fixed camera, or a patient in a bed.

Server acquires sound information from the acoustic collection apparatus as digitized audio samples.

In one embodiment, server uses a signal acquisition library to read pulse-code modulated (PCM) audio at a fixed sampling rate, such as 16 kHz or 22.05 kHz, and at a fixed bit depth, such as 16 bits.

Server segments the incoming stream into overlapping or non-overlapping frames, each containing a fixed number of samples. Server attaches time information to each frame using a system clock, and associates each frame with target identification information based on the corresponding device identifier.

Server acquires image information from the imaging apparatus as encoded video frames, for example, in a compressed video format. Server uses an image processing library such as a general-purpose computer vision library to decode the frames into raw images. Server resizes the decoded images to a standardized resolution, such as 224 by 224 pixels, converts them to a standardized color space, such as RGB, and optionally applies background separation using motion-based segmentation algorithms. Server assembles the processed frames into a time-series image sequence, where each frame entry is linked to time information and target identification information.

Server acquires environmental information from environmental sensors as timestamped numerical values. Server stores temperature, humidity, light levels, and other sensor readings with associated time information and target identification information. Server aligns environmental information with sound information and image information by time, thereby forming multimodal representations of the organism's context.

Server performs preprocessing of sound information using a signal processing program. In one example, server resamples incoming audio frames to a standard sampling rate and normalizes the amplitude to a fixed range, such as minus one to plus one. Server applies noise reduction using digital filters and spectral noise suppression. Server then computes a frequency-domain representation for each frame, for example, using a short-time Fourier transform or a Mel-frequency transform. Server stacks the resulting frequency-domain vectors over time to form a two-dimensional numerical array representing the evolution of sound over time and frequency.

Server performs preprocessing of image information using an image processing program. For each decoded and resized image, server normalizes pixel intensity values, for example, by scaling to a fixed range and subtracting a mean value. Server optionally performs background subtraction to isolate moving objects, and applies morphological operations to reduce noise. Server arranges the processed images into a time-series image sequence, and, in some embodiments, extracts additional features, such as optical flow patterns or object bounding boxes, using convolutional neural networks implemented in a machine learning framework.

Server generates a feature sequence representing behavior of the organism by combining sound-related features, image-related features, and, optionally, environmental features. For example, server concatenates sound feature vectors (derived from the frequency-domain representations) and visual feature vectors (derived from convolutional neural network outputs for each image frame) into a unified feature vector for each time step. Server adds environmental features, such as temperature and humidity, as additional dimensions in the feature vector. Server thus constructs a time-ordered sequence of high-dimensional feature vectors that captures the multimodal behavior and context of the organism.

Server inputs the feature sequence into an identification model implemented as a machine learning model for time-series data analysis. In one embodiment, server uses a neural network architecture that combines convolutional layers and recurrent layers. For example, server uses a convolutional sub-network to reduce the dimensionality of individual feature vectors, followed by a recurrent sub-network such as a long short-term memory (LSTM) network or a gated recurrent unit (GRU) network to capture temporal dependencies. In another embodiment, server uses a transformer-based architecture with self-attention layers that compute context-dependent representations for each time step. Server uses a loss function, such as cross-entropy for classification or a contrastive loss for clustering, to train the identification model on labeled or pseudo-labeled historical data. During training, server updates the weights of the model via gradient descent-based optimization algorithms.

Server uses the trained identification model to perform classification or clustering of behavior patterns. In a classification mode, server outputs probability distributions over predefined behavior categories, such as calm, stressed, alert, requesting water, or showing avoidance. In a clustering mode, server generates latent feature embeddings for each sequence and applies unsupervised clustering algorithms, such as k-means or density-based clustering, to group similar behavior patterns. Server stores the results as behavior pattern identifiers and associated statistical summaries, such as cluster centers and variance.

Server constructs and updates language system information in a storage unit. Language system information is a structured data set that describes correspondence relationships between behavior patterns and state information indicative of internal states or intentions. Server represents the language system information as, for example, a set of records in a database, where each record contains a behavior pattern identifier, one or more semantic state labels, description text, and associated confidence metrics. In some embodiments, server uses a graph-structured data model, where nodes represent behavior patterns and state concepts, and edges represent semantic relationships such as causality, similarity, or co-occurrence.

Server updates language system information as it processes more data. When new behavior patterns are detected, server adds new entries and associates them with provisional state labels. When user feedback or additional labeled data become available, server refines the mappings, adjusting probabilities and adding clarifying notes. This dynamic language system functions as a technical layer that connects low-level time-series patterns to high-level semantic descriptions, enabling the system to offer consistent explanations over time and across different organisms.

User operates a terminal such as a smartphone, tablet, or personal computer that runs a client application. Terminal provides a graphical user interface allowing user to select a target and to input a prompt sentence in natural language. For example, user enters prompt sentences such as “Is this plant asking for water now?”, “Is this plant stressed because of lack of water?”, “What does the bird sound mean right now?”, or “Does the bird in camera 2 feel threatened?”. Terminal sends these prompt sentences, together with target identification information and a suggested time range, to server over a network.

Server receives a prompt sentence from terminal and parses it using a natural-language processing component. Server identifies the target organism (for example, “this plant” or “the bird in camera 2”), extracts a time range if specified (for example, “now” or “today compared to yesterday”), and determines the question intention (for example, current state inquiry, cause inquiry, or recommendation inquiry). Server then selects the relevant behavior patterns and state information from the language system information that correspond to the target and time range.

Server generates context information by assembling a structured description of the organism's current or past state. This context information includes, for example, a summary of recent behavior patterns (such as frequency of leaf drooping, patterns of bird calls, or movement trajectories), associated state labels (such as requesting water or alert to danger), and environmental conditions.

Server converts this structured data into a textual description using a predefined template, ensuring that key technical details, such as observed pattern durations, estimated confidence, and relevant environmental conditions, are preserved.

Server generates a composite prompt sentence by combining the context information with the user-provided prompt sentence according to a prompt template. For example, server may produce a composite prompt that begins with a section labeled “Context,” followed by a section labeled “User question.” An example composite prompt may include text such as: “Context: The plant monitored by the first camera shows increasing leaf drooping in the last two hours, soil moisture sensor values are below a predefined threshold, and recent environmental data indicate high temperature and low humidity. According to the internal language system, this behavior pattern is associated with a state of requesting water. User question: ‘Is this plant asking for water now?’ Please answer concisely and explain the reasoning.”

Server inputs the composite prompt sentence into a generative AI model implemented on a local or remote computing resource. The generative AI model may be a transformer-based language model trained on large text corpora and fine-tuned for question-answering and explanation tasks. Server configures the generative AI model with parameters such as maximum output length, temperature, and decoding strategy (for example, greedy decoding or beam search) to ensure stable and reproducible outputs. Because server supplies detailed, structured context derived from the language system and the identification model, the generative AI model produces answers that are constrained by the underlying technical analysis rather than being purely free-form text generation.

Server receives an answer sentence in natural language from the generative AI model. The answer sentence includes at least one estimation of the state of the organism and, in some embodiments, an explanation of the reasoning. For example, the answer sentence may be: “Yes, based on the observed leaf drooping pattern and the low soil moisture, the plant is likely requesting water. Watering it now would reduce stress.” Or, in another example: “The bird's current calls match a pattern typically associated with an alert to potential danger nearby.” Server may append metadata such as confidence scores and references to specific behavior patterns, and then sends the answer sentence to terminal.

Terminal receives the answer sentence and displays it in the user interface. Terminal may show a conversation-like view where the original prompt sentence and the answer sentence are presented together. In some embodiments, terminal uses a text-to-speech engine to vocalize the answer. User reads or listens to the answer and may decide on a corresponding action, such as watering the plant, checking for predators, or adjusting environmental conditions.

From a technical perspective, server improves computer technology in multiple ways. First, server defines specific data structures (feature sequences, language system records, and composite prompts) that unify heterogeneous sensor data and internal model outputs, enabling efficient retrieval and reuse. By representing sound, image, and environmental information as standardized high-dimensional feature sequences and linking them to semantic state labels in language system information, server reduces the computational cost and complexity of context retrieval for each query, thereby improving response time and scalability.

Second, server employs time-series neural network architectures and structured language system construction to achieve higher accuracy and robustness than rule-based or static classification systems. By training identification models with appropriate loss functions and learning algorithms, server reduces misclassification of behavior patterns, which directly improves the technical quality of the generated answers. The system uses data augmentation and model regularization methods, such as sequence-level noise injection and dropout, to enhance generalization and reduce overfitting.

This leads to more reliable state estimation even under variable environmental conditions.

Third, server uses a non-conventional prompt handling mechanism that combines internal technical context and user queries into composite prompt sentences. This approach restricts the generative AI model to operate within a well-defined technical domain, improving consistency and reducing hallucinations. Because the generative AI model receives structured descriptions grounded in language system information, it can generate responses that are more tightly coupled with sensor data and model inferences, thereby improving technical interpretability and repeatability of the system.

Fourth, server reduces communication load and processing overhead by performing preprocessing and feature extraction close to the data source and by storing intermediate representations. Instead of transmitting raw video and audio continuously to external services, server computes compact feature sequences and behavior pattern summaries locally. This architecture lowers bandwidth requirements and decreases latency in responding to prompt sentences, which is a technical improvement in networked data processing.

In alternative embodiments, server uses different neural network architectures for the identification model, such as fully convolutional temporal networks or transformer encoders with multi-head attention. Server may adjust hyperparameters, such as layer depth, hidden dimension size, and attention head count, to balance computational cost and accuracy. Server may also implement different clustering methods, such as hierarchical clustering or spectral clustering, to discover behavior patterns. In each case, server continues to construct language system information that links discovered behavior patterns to state information.

In another embodiment, server adapts to different organism types by storing separate language system subsets and model configurations. For example, for plants, server may emphasize slow-changing visual features and soil moisture data, whereas for animals, server may emphasize vocalization spectrograms and motion trajectories. Server can thus reuse the same overall architecture but optimize internal parameters and feature selection strategies for each organism category, improving technical performance across diverse use cases.

User may issue a variety of prompt sentences to explore different aspects of the organism's state. For example, user may ask, “Is this plant comfortable with the current temperature and light?”, “Why is this cat meowing repeatedly near the door?”, “Has the tree shown signs of stress today compared to yesterday?”, or “What is this fish trying to express by swimming rapidly near the surface?”. For each of these prompt sentences, server applies the same technical framework: it parses the prompt, obtains relevant feature sequences and language system information, generates a composite prompt sentence, invokes the generative AI model, and delivers an answer sentence grounded in the system's internal analysis.

In sum, server, terminal, and user cooperate in a technically structured workflow in which server transforms continuous multimodal sensor data into model-ready features, organizes model outputs into a machine-readable language system, and uses composite prompt sentences to guide a generative AI model. This architecture yields concrete technical effects, including improved accuracy and robustness of state estimation, reduced computational and communication overhead, and enhanced interpretability and consistency of generated natural-language answers, thereby realizing a practical and repeatable implementation of the claimed invention.

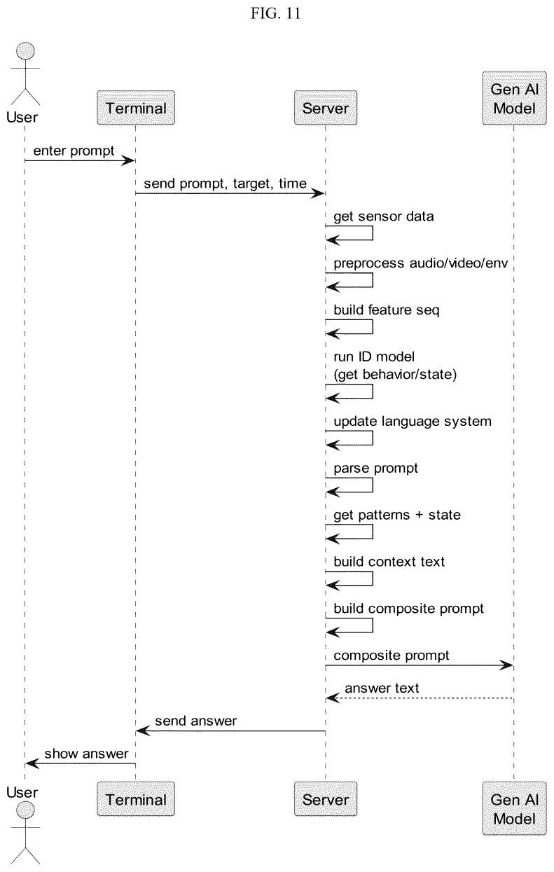

The following describes the processing flow using FIG. 11.

### Step 1:

Server acquires raw sensor data.

Server receives, as input, continuous streams of sound information from an acoustic collection apparatus, image information from an imaging apparatus, and environmental information from one or more environmental sensors. Server associates each incoming data unit with time information from a system clock and target identification information from a configuration table. Server writes raw audio buffers, encoded video frames, and sensor readings into temporary storage and an indexed database. As a result, server outputs timestamped and target-tagged raw data records that are ready for preprocessing.

### Step 2:

Server preprocesses sound information into frequency-domain features.

Server reads, as input, timestamped audio buffers for a given target and time range from storage.

Server normalizes the amplitude values, applies digital filters to reduce background noise, and segments the audio into overlapping frames of fixed length. Server computes, for each frame, a frequency-domain representation using a short-time Fourier transform or a Mel-frequency transform, thereby converting time-domain samples into a time-frequency matrix. Server stacks these matrices over time to form a two-dimensional numerical array (spectrogram or Mel-spectrogram) and stores it as a sound feature sequence. The output is a standardized sound feature sequence aligned with time information and target identification information.

### Step 3:

Server preprocesses image information into visual feature sequences.

Server reads, as input, timestamped encoded video frames for the same target and time range. Server decodes the video frames into raw images, resizes each image to a standardized resolution, converts the color space to a normalized format, and performs background separation or motion-based segmentation when applicable. Server may apply an image normalization step to scale pixel values to a uniform numeric range. Server then arranges the processed images into a time-ordered list to form a time-series image sequence. The output is a sequence of preprocessed frames, each linked to time information and target identification information.

### Step 4:

Server integrates environmental information with sound and image timelines.

Server retrieves, as input, environmental sensor readings (such as temperature, humidity, and illumination) for the specified target and time window. Server interpolates or resamples the environmental readings so that each sound frame and each image frame can be associated with corresponding environmental values. Server constructs, for each time step, a combined environmental feature vector. Server outputs aligned environmental feature sequences, where each element corresponds to a particular time index shared with the sound and image sequences.

### Step 5:

Server constructs unified multimodal feature sequences.

Server takes, as input, the sound feature sequence, the visual frame sequence, and the environmental feature sequence for a target. Server applies a convolutional neural network or another feature extractor to each image frame to obtain a visual feature vector, and optionally reduces the dimensionality of the sound feature vectors and environmental feature vectors by linear projections or small neural layers. Server concatenates the sound, visual, and environmental feature vectors for each aligned time index to form a unified multimodal feature vector. Server orders these unified vectors by time to produce a multimodal feature sequence that describes the organism's behavior and context. The output is a high-dimensional time-series feature sequence suitable for time-series analysis.

### Step 6:

Server analyzes multimodal feature sequences using a time-series identification model.

Server receives, as input, the multimodal feature sequence for a target. Server feeds the sequence into an identification model, such as a neural network with recurrent layers or self-attention layers, that is stored and executed on the processor, optionally using a GPU. Server computes, for each time step, forward activations through multiple layers (for example, convolutional layers followed by long short-term memory layers), and aggregates temporal information into latent representation vectors. Based on these latent representations, server calculates probability distributions over behavior categories or computes cluster assignments. Server outputs behavior pattern identifiers and associated state-related scores or embeddings that summarize the behavior of the organism over the analyzed time window.

### Step 7:

Server updates language system information based on detected behavior patterns.

Server accepts, as input, behavior pattern identifiers, probability distributions, latent embeddings, and existing language system records from a storage unit. Server compares newly detected patterns with stored patterns using similarity metrics, such as distance in embedding space, and decides whether a detected pattern matches an existing pattern or constitutes a new pattern. Server then updates or inserts records that associate each behavior pattern with state information, such as an internal state label (for example, requesting water, alert to danger, or calm) and descriptive text.

Server writes the updated language system information back to the storage unit. The output is an enriched, up-to-date language system that links behavior patterns to semantic state representations.

### Step 8:

User initiates a query by entering a prompt sentence on terminal.

User views a list of available targets on terminal and selects a specific organism, such as a particular plant, bird, or patient. User then inputs, as prompt sentence, a natural-language question into a text field. Examples of the input include: “Is this plant asking for water now?”, “Is this plant stressed because of lack of water?”, “What does the bird sound mean right now?”, and “Does the bird in camera 2 feel threatened?”. Terminal packages the selected target identification information, an optional time range (for example, “now” or “today”), and the prompt sentence, and outputs a structured request to server over the network.

### Step 9:

Server parses the prompt sentence and extracts query parameters.

Server receives, as input, the structured request from terminal containing the prompt sentence, target identification information, and optional time parameters. Server tokenizes the prompt sentence and applies a natural-language parsing algorithm to identify key elements, such as the referenced target, the temporal scope (current, past day, comparison window), and the question intention (state inquiry, cause inquiry, recommendation). Server reconciles these extracted elements with the provided target ID and time range to derive finalized query parameters. The output is a set of structured query parameters, including a resolved target, a concrete time window, and a machine-interpretable representation of the question intention.

### Step 10:

Server retrieves relevant behavior patterns and associated language system entries.

Server uses, as input, the query parameters generated in Step 9. Server queries its database for behavior pattern records and analysis results for the specified target and time window. Server selects the most recent or most relevant behavior patterns along with their associated state labels, probability scores, and explanatory language system entries. Server may also retrieve representative feature snippets, such as characteristic sound segments or image frames, to support explanation. The output is a structured set of context elements that describe the target's recent behavior and inferred states.

### Step 11:

Server generates context information describing the organism's state.

Server takes, as input, the retrieved behavior patterns, state labels, language system descriptions, and relevant environmental summaries. Server synthesizes this information into a consolidated description of the target's current or past state, including, for instance, typical behavior during the selected time window, deviations from baseline, and confidence levels for specific state inferences.

Server formats this description as text, using a fixed context template that highlights key features such as “frequent leaf drooping,” “low soil moisture,” or “high-pitched repeated calls.” The output is a context text that is technically grounded in internal data structures and model outputs.

### Step 12:

Server constructs a composite prompt sentence for the generative AI model.

Server receives, as input, the context text from Step 11 and the original prompt sentence from the user. Server inserts the context text and the prompt sentence into a predefined prompt template that defines the order, labeling, and formatting of each part. For example, server may create a composite prompt in which the context text appears under a “Context” heading and the user's question appears under a “User question” heading. Server ensures that the composite prompt explicitly mentions the key behavior patterns and state labels from the language system. The output is a composite prompt sentence that encapsulates both system-generated context and user intent.

### Step 13:

Server invokes the generative AI model to generate an answer sentence.

Server supplies, as input, the composite prompt sentence from Step 12 to a generative AI model running locally or hosted remotely. Server sets generation parameters such as maximum number of tokens and temperature to control output length and variability. Server transmits the composite prompt to the model and receives an auto-regressively generated natural-language response from the model. The model conditions its generation on the provided context text and the user question, producing an answer that estimates the organism's state and often includes an explanation. The output of this step is an answer sentence that reflects both the language system information and the specific query.

### Step 14:

Server post-processes the generated answer and prepares a response for terminal.

Server takes, as input, the raw answer sentence produced by the generative AI model. Server optionally checks the answer for alignment with stored state labels and behavior patterns, and may append additional technical metadata such as confidence indicators or references to particular behavior patterns. Server then encapsulates the answer sentence, and any associated metadata, into a response object suitable for network transmission. The output is a formatted response containing the answer sentence to be sent to terminal.

### Step 15:

Terminal displays the answer sentence and supports follow-up interaction.

Terminal receives, as input, the response from server containing the answer sentence and any supplemental data. Terminal presents the answer sentence in a user interface element, such as a chat-like window, showing the original prompt sentence and the returned answer sentence together.

Terminal may convert the text to speech if enabled by user. User reads or listens to the answer and may formulate a new prompt sentence based on the provided information, thereby starting another interaction cycle by sending a further query to server.

### Application Example 1

Description Follows Regarding a Flow of the Specific Processing in an Application Example 1. The units of the system described below are implemented by the data processing device 12 and the smart device 14. The data processing device 12 is called a “server” and the smart device 14 is called a “terminal”.

Conventional computer-implemented monitoring systems for living organisms and plants are typically designed as narrow, rule-based applications that separately process sensor data such as images, sounds, and environmental measurements. Such systems generally (i) treat each modality in isolation, (ii) rely on manually crafted thresholds for anomaly detection, and (iii) provide only low-level numerical outputs or simple alerts. As a result, these systems are unable to construct a coherent representation of the internal state of living organisms and plants, cannot robustly distinguish between normal variation and meaningful anomalies, and cannot express their analysis in a form that is understandable and actionable for human operators.

Further, conventional systems that employ machine learning models usually focus on a fixed classification task, such as detecting disease symptoms from images or identifying stress from sound patterns. These models do not learn a reference model of “normal” behavior across multiple sensor modalities and over time, and therefore exhibit reduced robustness when the environment or growth stage changes. In addition, such models are generally not integrated with generative artificial intelligence models that can accept prompt sentences from a user and generate natural-language explanations tailored to the user's query and the current sensor context. Consequently, human operators must manually interpret raw scores or class labels, which increases cognitive load and introduces inconsistency in decision making.

Moreover, existing systems for environmental control in factories, greenhouses, or animal facilities usually implement simple feedback loops based on static thresholds, such as turning on irrigation when humidity is below a certain level. These systems do not dynamically link detected anomalies in behavior or appearance of living organisms and plants with high-level, human-interpretable language descriptions and with specific, context-dependent control commands. There is thus no integrated computational framework that: (i) continuously learns normal patterns from multimodal sensor data; (ii) detects deviations as health-related anomalies; (iii) maps such anomalies into a language system that is directly usable by generative AI models; and (iv) automatically translates both model evaluations and generative explanations into actionable control commands for environment control apparatuses and work machines.

In addition, for humans in non-responsive plant-like states, conventional communication technologies are limited to basic signal monitoring or simple binary responses, and do not exploit a unified framework that treats brain activity signals and biological signals as part of a broader multimodal representation processed by generative AI models to infer internal states and generate natural-language explanations. This leads to underutilization of available computational resources and an inability to provide consistent, interpretable feedback regarding such internal states.

Accordingly, there is a need for an improved computer-implemented system and processing architecture that: (1) integrates multimodal sensor acquisition, feature extraction, and model-based anomaly detection into a unified reference model of normal states for living organisms and plants; (2) constructs and maintains a language system that associates internal and environmental states with human-readable descriptions; (3) uses generative AI models in response to user prompt sentences to generate context-aware natural-language explanations and recommendations; and (4) automatically derives and executes environment adjustment commands in a closed feedback loop. Such a system would improve the technical performance of anomaly detection, reduce manual interpretation burden, enhance adaptability through continuous learning, and thereby provide a concrete improvement in computer technology for monitoring and interacting with living organisms, plants, and non-responsive humans.

The specific processing by the specific processing unit 290 of the data processing device 12 in Application Example 1 is realized by the following means.

The present invention provides a server comprising a processor configured to acquire bioacoustic information, motion information, and environmental information of living organisms and plants from one or more sensor devices; preprocess the acquired information to generate multidimensional feature vectors including image features, acoustic features, and environmental features; apply a machine learning model to the multidimensional feature vectors to learn and maintain a reference model representing a normal state of the living organisms and the plants, and to evaluate a health state and calculate an abnormality degree based on a reconstruction error or similarity with respect to the reference model; construct a language system that associates internal states and environmental states of the living organisms and the plants with human-readable descriptions based on the abnormality degree and the multidimensional feature vectors; analyze a prompt sentence input from a user, generate an input text including the prompt sentence, the abnormality degree, and the multidimensional feature vectors, and provide the input text to a generative artificial intelligence model to generate a natural-language answer relating to the state of the living organisms and the plants; determine environmental adjustment content for maintaining or improving the health state based on an evaluation result of the health state or the generated natural-language answer, generate a control command representing the environmental adjustment content, and transmit the control command to an environment control apparatus or a work machine to cause execution of a physical environmental adjustment operation, and thereafter reacquire the state of the living organisms and the plants and repeat the evaluation of the health state and the determination of the environmental adjustment content to perform feedback control. This enables an integrated, computer-implemented pipeline in which multimodal sensor data are converted into a learned reference model of normal states, deviations are automatically detected and expressed as human-readable explanations via a language system and a generative AI model in response to user prompt sentences, and corresponding environment adjustment commands are automatically derived and executed, thereby improving the accuracy, adaptability, and interpretability of computer-based monitoring and control for living organisms, plants, and non-responsive humans.

The term “processor” refers to a hardware or virtual computing element, such as a central processing unit, a graphics processing unit, or a programmable logic device, that executes instructions to perform data acquisition, preprocessing, model inference, and control operations.

The term “bioacoustic information” refers to sound information generated by living organisms or plants, including vocalizations, movement-related noises, and other biologically originated acoustic signals detectable by an acoustic sensor.

The term “motion information” refers to information indicating spatial movement or postural change of a living organism or plant, including body motions, leaf movements, and other position or shape variations detectable from image data or motion sensors.

The term “environmental information” refers to information representing physical conditions in a surrounding space, including at least one of temperature, humidity, illumination intensity, gas concentration, vibration, and ambient noise level.

The term “living organisms and plants” refers to biological entities including animals and plants, and may also encompass groups or populations of such entities monitored as a unit.

The term “sensor device” refers to a hardware component configured to detect physical phenomena and output corresponding signals, and includes at least one of an image acquisition device, an acoustic acquisition device, an environmental measurement device, and a physiological signal measurement device.

The term “image features” refers to numerical values or representations extracted from image data, such as color distributions, texture descriptors, shapes, contours, or learned feature vectors produced by an image analysis model.

The term “acoustic features” refers to numerical values or representations extracted from acoustic data, such as frequency spectra, temporal patterns, pitch statistics, energy distributions, or learned feature vectors produced by an acoustic analysis model.

The term “environmental features” refers to numerical values or representations derived from environmental information, including raw measurement values and transformed indicators such as normalized temperature indices, humidity indices, or trend values over time.

The term “multidimensional feature vector” refers to a structured numerical representation that aggregates two or more of image features, acoustic features, and environmental features into a single vector suitable for processing by a machine learning model.

The term “machine learning model” refers to a computational model, such as a neural network, an autoencoder, a probabilistic model, or an ensemble model, that is trained on data to discover patterns and perform tasks including classification, regression, reconstruction, or anomaly detection.

The term “reference model” refers to a machine learning model or statistical representation that characterizes a normal or healthy state of living organisms and plants, based on multidimensional feature vectors obtained under non-abnormal conditions.

The term “normal state” refers to a state of living organisms and plants regarded as healthy or typical for a given context, time period, or environment, and used as a baseline for comparison with current states.

The term “health state” refers to an evaluated condition of living organisms and plants, indicating whether the organisms or plants are in a normal, warning, or abnormal condition, based on comparison with the reference model.

The term “reconstruction error” refers to a difference measure between an input multidimensional feature vector and a corresponding output produced by a model trained to reconstruct the input, the measure being indicative of deviation from normal behavior.

The term “similarity” refers to a quantitative metric, such as a distance or correlation, that expresses how closely a current multidimensional feature vector or state matches a representation stored in the reference model.

The term “abnormality degree” refers to a numerical or categorical indicator of how strongly a current state of living organisms and plants deviates from the normal state as defined by the reference model, based on at least one of reconstruction error and similarity.

The term “language system” refers to a structured association between numerical or symbolic representations of internal and environmental states and human-readable linguistic expressions that describe those states.

The term “human-readable descriptions” refers to natural-language or structured text expressions understandable by a human operator, describing internal states, environmental states, or recommended actions.

The term “prompt sentence” refers to a natural-language input expression provided by a user, which specifies a request, query, or instruction for estimating, explaining, or reporting the state of living organisms and plants or related control actions.

The term “input text” refers to a textual representation constructed for provision to a generative artificial intelligence model, the representation including at least a prompt sentence and additional structured or descriptive data.

The term “generative artificial intelligence model” refers to a machine learning model configured to generate new natural-language text or other content in response to input text, such as a transformer-based language model trained on large amounts of text data.

The term “natural-language answer” refers to a text output produced by a generative artificial intelligence model in a human language, describing or explaining states of living organisms and plants or recommending actions.

The term “environmental adjustment content” refers to information specifying one or more desired changes to environmental conditions, such as target levels, durations, or intensities, for maintaining or improving the health state of living organisms and plants.

The term “control command” refers to a machine-readable instruction or set of parameters transmitted to an environment control apparatus or a work machine to cause execution of a specified physical operation.

The term “environment control apparatus” refers to a hardware device configured to adjust at least one environmental parameter, such as an irrigation device, a heating or cooling device, a humidification device, a lighting device, or a noise reduction device.

The term “work machine” refers to a hardware device or robotic system configured to perform physical tasks in an environment, including movement, manipulation, or operation of tools for adjusting environmental conditions.

The term “physical environmental adjustment operation” refers to an action performed by an environment control apparatus or a work machine that changes at least one environmental condition, such as supplying water, changing temperature, changing humidity, changing illumination, or reducing noise.

The term “feedback control” refers to a control scheme in which the system reacquires data after execution of an environmental adjustment operation, re-evaluates the health state, and adjusts future control commands based on the updated evaluation.

The term “brain activity signals” refers to electrical or physiological signals indicative of neural activity of a human, measurable by a brain function measurement device.

The term “biological signals” refers to physiological signals generated by a human body other than brain activity signals, such as heart-related signals, muscle-related signals, respiratory signals, or skin conductance.

The term “feature vector” refers to a numerical representation extracted from brain activity signals or biological signals and used as input to a machine learning model or a generative artificial intelligence model.

The term “internal state of a human in a non-responsive plant-like state” refers to a condition of a human who does not exhibit conscious behavioral responses but may have underlying neural or physiological activity inferable from brain activity signals and biological signals.

The term “relearning or additional learning” refers to a process of updating parameters of a machine learning model or a generative artificial intelligence model using newly collected data, without necessarily discarding previously learned parameters.

In one embodiment, a server, a terminal, and a plurality of sensor devices are deployed in a facility such as a factory, greenhouse, or animal housing environment in which living organisms and plants are managed. The server includes at least one processor, a memory, a network interface, and a non-transitory storage medium storing program code for implementing the functions described below. The terminal includes an input/output interface, a display, and a communication module configured to communicate with the server via a wired or wireless network.

The server uses hardware input devices including one or more image acquisition devices, one or more acoustic acquisition devices, and one or more environmental measurement devices. In a concrete configuration, the image acquisition device may be an industrial network camera; the acoustic acquisition device may be a microphone array; and the environmental measurement devices may include temperature sensors, humidity sensors, gas concentration sensors, light sensors, and noise level sensors connected through an Internet-of-Things gateway. The server executes an operating system such as a general-purpose server operating system and uses driver software for each sensor device. The server uses a software library such as OpenCV for image processing, an audio processing library such as Librosa, and a numerical computation framework such as TensorFlow or PyTorch for machine learning and deep learning.

The server acquires bioacoustic information, motion information, and environmental information of the living organisms and the plants. The server receives image streams from the network cameras and decodes compressed image data into two-dimensional or three-dimensional arrays of pixel values. The server receives audio streams from the microphone array as digital samples, for example in 16-bit pulse code modulation at a fixed sampling rate. The server also receives environmental measurements from the environmental measurement devices via a message protocol such as a publish/subscribe protocol. The server stores raw sensor data in a structured data store such as a relational database or a time-series database, with each record being tagged with a timestamp, sensor identifier, and zone identifier.

The server preprocesses the acquired data to generate multidimensional feature vectors including image features, acoustic features, and environmental features. For the image data, the server uses OpenCV to resize each frame to a predetermined resolution, convert the color space, normalize pixel values, and optionally apply filters such as Gaussian blur, edge enhancement, or morphological operations to emphasize contours of leaves or bodies. The server may further segment each frame to isolate a region corresponding to a particular plant or animal based on background subtraction or contour detection. The server then passes the preprocessed image data through a convolutional neural network, such as a ResNet-type or EfficientNet-type architecture implemented in TensorFlow or PyTorch, and extracts an intermediate layer output as an image feature vector representing high-level attributes such as color distribution, texture, shape, and posture.

For the audio data, the server uses Librosa or a similar library to convert time-domain signals into time-frequency representations, such as mel-spectrograms or mel-frequency cepstral coefficients.

The server applies noise reduction or band-pass filtering to suppress machine noise and emphasize bioacoustic components. The server then inputs these time-frequency representations to an acoustic analysis network, such as a convolutional neural network or a convolutional-recurrent hybrid network. The server obtains an acoustic feature vector representing vocalization patterns, call rates, pitch distributions, and temporal dynamics of the sound signals generated by the living organisms and the plants.

For the environmental information, the server aggregates and normalizes measurements over fixed time windows, such as one-minute or five-minute intervals. The server may apply interpolation for missing sensor values and derive additional indicators, such as moving averages or rate of change of humidity and temperature. The server concatenates normalized environmental measurements into an environmental feature vector.

The server combines the image feature vector, the acoustic feature vector, and the environmental feature vector into a single multidimensional feature vector for each target entity and time window.

The server uses a consistent feature ordering and data structure, for example a fixed-length array or tensor, to facilitate batch processing by subsequent models. This explicit feature structuring improves computation efficiency and cache locality when the processor performs matrix operations during model inference.

The server uses the multidimensional feature vector as input to a machine learning model to learn and maintain a reference model representing a normal state of the living organisms and the plants. In one embodiment, the server implements an autoencoder neural network comprising an encoder sub-network and a decoder sub-network. The encoder sub-network may include multiple fully connected layers or a combination of fully connected layers and recurrent layers, such as long short-term memory layers, to capture temporal dependencies across time windows. The decoder sub-network mirrors the encoder structure and reconstructs the input feature vector from a compressed latent representation.

The server trains the autoencoder using datasets corresponding to known normal states. The server uses a loss function such as mean squared error between the input feature vector and the reconstructed feature vector. The server updates network weights by an optimization algorithm, such as stochastic gradient descent or an adaptive method such as Adam, until the reconstruction error converges below a predetermined threshold. The server thereby obtains a reference model that encodes the statistical characteristics of normal states across different sensor modalities and time periods. The server also computes and stores baseline statistics, such as average reconstruction error and standard deviation, for use in anomaly scoring.

During operation, the server inputs current multidimensional feature vectors into the trained autoencoder. The server computes reconstruction errors and converts them into an abnormality degree by comparing them with the baseline statistics, for example by normalizing the reconstruction error or applying a thresholding function. The server optionally combines the reconstruction-based abnormality degree with additional similarity metrics, such as cosine similarity between the current latent representation and stored latent representations for normal states. As a result, the server obtains a robust measure of deviation that is less sensitive to sensor noise and natural variation. This approach improves accuracy compared with simple rule-based thresholds, and reduces false positives and false negatives in anomaly detection.

The server constructs a language system that associates internal and environmental states with human-readable descriptions based on the abnormality degree and the multidimensional feature vectors. In one embodiment, the server defines a set of symbolic categories corresponding to underlying technical conditions, such as dehydration risk, heat stress, nutrient imbalance, or acoustic stress. The server learns mappings from regions in the feature space and ranges of abnormality degrees to such categories, for example by training a classifier or by rule-based conditions derived from empirical data. The server then defines template expressions and parameterized phrases in a natural language for each category, and associates numerical values such as severity scores or duration with linguistic modifiers.

The server further uses a generative AI model, such as a transformer-based language model running on the server, to flexibly combine the categories, numerical parameters, and user-provided context into free-form natural-language explanations. The server constructs an input text for the generative AI model that includes (i) a prompt sentence from a user, (ii) abnormality degrees, (iii) key feature summaries, and (iv) category labels derived from the language system. In this way, the server does not merely use a static template system, but provides structured, semantically rich context that the generative AI model can use to generate explanations that are both context-aware and technically grounded.

The terminal provides a user interface for receiving a prompt sentence and displaying generated explanations. The user uses the terminal to select a target zone, a target plant, or a target animal, and then inputs a prompt sentence. Example prompt sentences include:

“Analyze the leaf movements, color changes, and humidity data for this plant over the last 24 hours and determine whether dehydration occurred. Provide a risk level and recommended watering schedule.”

“Based on the audio data and detected vocalization patterns from this animal, estimate the current stress level and describe the main environmental factors contributing to it.”

“Using the images, motion data, and environmental logs from zone C for the past 7 days, summarize the overall health status of the plants, identify any abnormal patterns, and propose adjustments to watering, lighting, and temperature.”

The terminal transmits the prompt sentence and selection parameters to the server. The server retrieves relevant sensor data and derived feature vectors from the database and constructs the input text that embeds these data in a structured descriptive form. The server then applies the generative AI model to the input text and obtains a natural-language answer. The server transmits the answer to the terminal, and the terminal displays the answer to the user.

The server determines environmental adjustment content for maintaining or improving the health state based on an evaluation result of the health state or the generated natural-language answer. In one embodiment, the server uses rule-based logic that maps detected categories and severity levels to target environmental parameter changes, such as a specified amount of water, a target humidity range, a target temperature range, or a target light intensity. The server then generates a control command including these parameters in a machine-readable format and transmits the command to an environment control apparatus or a work machine.

The environment control apparatus may include irrigation equipment, ventilation equipment, heating or cooling equipment, humidification or dehumidification equipment, lighting equipment, or sound insulation equipment. A work machine such as a robotic arm or a mobile robot may be used to physically move nozzles, open or close valves, or reposition equipment. The server sends control commands over a control network and may employ a middleware such as a robot control framework to route commands to specific actuators.

The server thereafter reacquires sensor data after the execution of environmental adjustment operations and repeats the evaluation of the health state and the determination of environmental adjustment content, thereby implementing feedback control. Because the reference model, the language system, and, optionally, the generative AI model are periodically retrained or updated using newly collected data, the system adapts to seasonal changes, growth stages, and long-term shifts in environmental conditions. This continual learning and adaptation yields improved prediction accuracy and reduced need for manual recalibration compared with systems using fixed thresholds or static models.

The server may also acquire brain activity signals and biological signals of a human in a non-responsive plant-like state. The server uses specialized hardware such as a brain function measurement device and a physiological signal measurement device to obtain these signals. The server preprocesses such signals by filtering, artifact removal, and feature extraction, for example by computing power spectral densities or time-frequency representations for brain activity signals. The server converts the resulting feature vectors into an input form acceptable to the generative AI model and uses the same language system and generative AI infrastructure to infer internal states and generate natural-language explanations. This configuration extends the unified multimodal framework to non-responsive humans.

This system architecture provides specific technical improvements beyond simple automation of human observation. By structurally integrating heterogeneous sensor data into a multidimensional feature vector, applying a learned reference model based on an autoencoder or similar architecture, and computing abnormality degrees and category labels, the server reduces noise sensitivity and increases robustness in anomaly detection. This leads to higher accuracy in health state estimation compared with manual inspection or threshold-only systems.

Furthermore, because the server performs feature extraction using optimized matrix operations and deep network inference on hardware such as a graphics processing unit, the server can process large volumes of high-frequency sensor data in near real time. The autoencoder-based reference model, which compresses high-dimensional input into a lower-dimensional latent space, reduces the computational complexity of similarity and anomaly calculations compared with directly operating on raw sensor data. As a result, the server improves processing speed and reduces memory bandwidth usage, which are concrete improvements in computing efficiency.

The server also improves data management by storing both raw data and derived feature vectors with consistent identifiers and timestamps, enabling efficient retrieval for both inference and retraining.

The explicit design of the language system, which maps internal model outputs to structured linguistic descriptors, reduces ambiguity and improves interpretability for operators, while still leveraging the flexibility of a generative AI model. This combination yields a technically distinct mechanism for human-machine interaction in which a generative AI model is tightly coupled to a domain-specific feature space and reference model, rather than being used as a generic conversational agent.

The system operates according to rules and procedures that differ from traditional human reasoning.

For example, the server determines dehydration risk not by applying a simple humidity threshold, but by evaluating reconstruction errors in a latent feature space spanning visual, acoustic, and environmental dimensions. The server then uses these model-generated abnormality degrees as inputs to the language system and control decision logic. This non-intuitive, data-driven approach allows the system to detect subtle precursors to health degradation that are not easily noticed by humans and to adjust control actions preemptively. The causal relationship between the use of the learned reference model, the construction of the language system, and the resulting reduction in misclassification and delayed responses provides a technical effect in the form of improved control stability and resource utilization.

Alternative embodiments may use different neural network architectures, such as variational autoencoders, transformer-based sequence models, or graph neural networks to capture relationships among multiple plants or animals. The server may implement different loss functions, such as Kullback-Leibler divergence or contrastive loss, depending on the modeling objective. The server may also employ data augmentation techniques, such as random cropping, rotation, or noise injection for images and audio, to improve generalization. In some embodiments, the server performs federated learning across multiple facilities, aggregating model updates rather than raw data, thereby reducing communication load and preserving data locality.

The terminal may be realized as a handheld terminal, a desktop terminal, or a dedicated control console. The user may employ voice input rather than text input to provide a prompt sentence, in which case the terminal includes a speech recognition module and transmits the recognized text as the prompt sentence. The user may also issue an instruction such as “Apply the recommended watering schedule automatically,” in which case the server generates a sequence of control commands according to the parameters suggested in the generated natural-language answer and schedules them for execution.

Through these configurations and variations, the server, the terminal, and the sensor and control devices cooperate to implement the claimed system in a manner that is reproducible and technically specific. The integration of a learned reference model, a structured language system, and a generative AI model, combined with direct control of environment control apparatuses and work machines, achieves concrete improvements in computer technology in terms of processing speed, accuracy, computational efficiency, and interpretability, while providing a practical mechanism for monitoring and controlling the health state of living organisms, plants, and non-responsive humans.

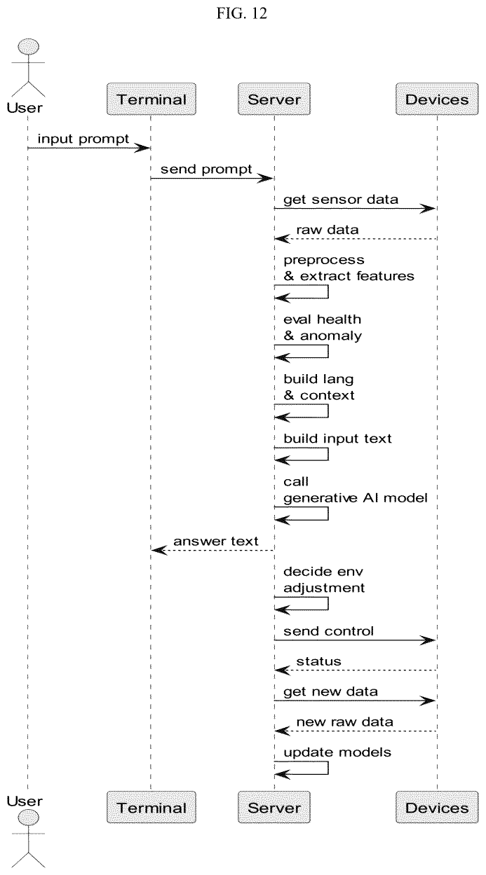

The following describes the processing flow using FIG. 12.

### Step 1:

Server acquires raw sensor data from the environment.

Server receives, as input, image streams from an image acquisition device, audio streams from an acoustic acquisition device, and numerical measurements from environmental measurement devices.

Server decodes compressed image data into frame arrays of pixel values, reads audio samples as digital waveforms, and parses environmental messages to obtain temperature, humidity, illumination, and other sensor readings.

Server timestamps each data item, attaches identifiers such as sensor ID, zone ID, and organism/plant ID, and stores the raw data records in a data store.

The output of Step 1 is a set of time-aligned raw image frames, raw audio segments, and raw environmental measurement records with associated metadata.

### Step 2:

Server performs preprocessing and feature extraction for each modality.

Server receives, as input, the raw image frames, raw audio segments, and raw environmental measurements from Step 1.

Server uses image processing software to resize each frame to a standardized resolution, convert color space, normalize pixel intensities, and optionally segment regions corresponding to target plants or animals.

Server uses an audio processing library to compute time-frequency representations such as mel-spectrograms or cepstral coefficients from the audio waveforms, applying filters to suppress background noise.

Server aggregates environmental measurements over predefined time windows and normalizes them by applying scaling and, where needed, interpolation.

Server passes preprocessed images through a convolutional neural network and extracts intermediate activations as image feature vectors; server passes time-frequency audio representations through an acoustic neural network and extracts activations as acoustic feature vectors; server converts normalized environmental values into an environmental feature vector.

The output of Step 2 is, for each time window and target entity, a set of structured image feature vectors, acoustic feature vectors, and environmental feature vectors.

### Step 3:

Server constructs a multidimensional feature vector for integrated analysis.

Server receives, as input, the image feature vectors, acoustic feature vectors, and environmental feature vectors from Step 2.

Server concatenates these vectors in a predetermined order into a single multidimensional feature vector, optionally applying dimensionality reduction or normalization across modalities.

Server ensures that each multidimensional feature vector is associated with a time index and target entity identifier, and stores the vectors in a feature database or in memory for batch processing.

The output of Step 3 is a sequence of multidimensional feature vectors representing multimodal states of living organisms and plants over time.

### Step 4:

Server performs learning and updating of a reference model for normal states.

Server receives, as input, multidimensional feature vectors labeled or designated as representing normal or healthy conditions.

Server initializes a machine learning model, such as an autoencoder neural network, and feeds batches of normal-state feature vectors to the model during training.

Server computes reconstruction outputs of the autoencoder, calculates reconstruction errors using a loss function such as mean squared error, and updates model weights via an optimization algorithm.

Server iteratively repeats this computation over multiple epochs until convergence criteria are met, thereby obtaining a reference model that compactly represents normal behavior in latent space.

Server computes baseline reconstruction error statistics and stores both the trained model parameters and baseline metrics.

The output of Step 4 is a trained reference model with associated baseline statistics for normal states.

### Step 5:

Server evaluates current health states and calculates abnormality degrees.

Server receives, as input, current multidimensional feature vectors from Step 3 and the trained reference model from Step 4.

Server applies the reference model to each current feature vector to produce reconstructed vectors and computes reconstruction errors by comparing each input vector to its reconstruction.

Server normalizes reconstruction errors using the stored baseline statistics and optionally combines them with similarity metrics between latent representations to generate an abnormality degree for each time window and entity.

Server classifies each state as normal, warning, or abnormal based on the abnormality degree and predefined thresholds, and assigns one or more internal categories such as dehydration risk, heat stress, or acoustic stress.

The output of Step 5 is a set of health state evaluations, abnormality degrees, and associated internal categories for each monitored entity.

### Step 6:

Server constructs and maintains a language system that links model outputs to human-readable concepts.

Server receives, as input, the abnormality degrees, internal categories, and selected components of the multidimensional feature vectors from Step 5.

Server maps ranges of abnormality degrees and combinations of categories to symbolic descriptors that represent internal and environmental states, and associates these descriptors with parameterized natural-language phrases.

Server updates a language mapping table or model structure that defines how quantitative model outputs are translated into qualitative descriptions such as “mild dehydration,” “continued low humidity,” or “rapid temperature fluctuations.”

The output of Step 6 is an updated language system that can convert numerical and categorical model outputs into structured human-readable descriptions.

### Step 7:

Terminal accepts a prompt sentence from a user and transmits it to the server.

User views a graphical interface on the terminal and selects a target organism, plant, or zone and a time range of interest.

User enters, as input, a prompt sentence describing a desired analysis or explanation, such as:

“Analyze the leaf movements, color changes, and humidity data for this plant over the last 24 hours and determine whether dehydration occurred. Provide a risk level and recommended watering schedule.”

Terminal packages the prompt sentence together with the selected target identifier and time range into a request message and sends this message to the server over a network connection.

The output of Step 7 is a request received by the server that contains a user prompt sentence and context parameters.

### Step 8:

Server constructs an input text for a generative AI model based on model outputs and the prompt sentence.

Server receives, as input, the user prompt sentence and context parameters from Step 7, as well as stored health state evaluations, abnormality degrees, internal categories, and relevant feature summaries from Steps 3, 5, and 6 for the specified target and time range.

Server formats these elements into a structured textual description, which may include sections such as recent averages, detected anomalies, severity levels, and environmental trends.

Server embeds this description together with the user prompt sentence into a composite input text designed for the generative AI model, ensuring that domain-specific data are clearly labeled and separated from the user's question.

The output of Step 8 is a composite input text that combines the user prompt sentence with processed model outputs and contextual information.

### Step 9:

Server generates a natural-language answer using the generative AI model.

Server receives, as input, the composite input text from Step 8.

Server forwards the composite input text to a generative AI model, such as a transformer-based language model, executed on the server or on a connected computing resource.

Server causes the generative AI model to perform tokenization, context encoding, and autoregressive decoding based on learned parameters, thereby producing a sequence of output tokens that form a natural-language answer relating to the health state and recommended actions.

Server reconstructs the token sequence into a text string and applies optional post-processing such as truncation or formatting.

The output of Step 9 is a natural-language answer that explains the state of the living organisms and plants and may include recommended environmental adjustments.

### Step 10:

Server determines environmental adjustment content based on model evaluations and the generated answer.

Server receives, as input, the health state evaluations and abnormality degrees from Step 5, the internal categories from Step 6, and the natural-language answer from Step 9.

Server parses the content of the generated answer, extracts quantitative recommendations such as water volume, humidity range, temperature change, or timing, and aligns these with internal control rules that constrain allowable adjustments.

Server combines extracted recommendations with internal thresholds and device capabilities to compute specific environmental adjustment content, such as a target humidity increase of a certain percentage or a watering amount for a specific duration.

The output of Step 10 is a set of structured control parameters representing environmental adjustment content for each relevant environment control apparatus or work machine.

### Step 11:

Server generates and transmits control commands to environment control devices.

Server receives, as input, the structured control parameters from Step 10.

Server converts these parameters into device-specific control command messages, including target device identifiers, action types, target values, and execution durations.

Server transmits the control command messages over the control network to the corresponding environment control apparatuses or work machines, such as irrigation devices, ventilation systems, or robotic manipulators.

The output of Step 11 is a set of transmitted control commands that cause environment control devices to perform physical adjustment operations.

### Step 12:

Server monitors post-adjustment effects and updates models through feedback.

Server receives, as input, new raw sensor data from image, audio, and environmental measurement devices after execution of the control commands in Step 11.

Server repeats Steps 2 and 3 to obtain updated multidimensional feature vectors and applies the reference model as in Step 5 to obtain updated abnormality degrees and health state evaluations.

Server compares pre-adjustment and post-adjustment abnormality degrees and feature values to compute improvement metrics, such as reduction in deviation from normal or stabilization of environmental parameters.

Server stores these metrics and, at scheduled intervals, uses aggregated data to perform relearning or additional learning of the reference model and to refine the language system, thereby adapting thresholds and descriptions to long-term changes.

The output of Step 12 is an updated model state and language system that reflect the outcomes of past control actions and improve future detection and explanation performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for monitoring or interacting with animals, plants, and other non-verbal entities primarily rely on narrowly scoped sensing and rule-based processing. For example, known monitoring devices capture limited sensor streams, perform simple thresholding or pattern matching, and then generate fixed alerts. Such architectures suffer from several technical deficiencies when implemented on general-purpose computing hardware. First, the processor is forced to handle heterogeneous data streams (audio, video, environmental signals, user inputs) in separate, loosely coupled pipelines, which leads to inefficient memory usage, redundant computation, and increased latency. Second, prompt-based user interaction, where a user provides a natural-language instruction or question to the system, is not natively integrated into the data-processing pipeline. As a result, the processor cannot adapt its analysis to the specific user intent expressed in a prompt sentence, and must instead run generic, preconfigured analyses that either over-process or under-utilize available computational resources.

Third, existing machine learning systems that attempt to estimate the state of animals or plants typically treat model inference as a one-way mapping from sensor data to labels. They do not maintain an integrated, machine-readable behavior pattern model per individual over time, nor do they tightly couple that model with subsequent inference and generation processes. This causes fragmentation of state information across databases and application logic, leading to cache inefficiencies, repeated model loading, and suboptimal GPU utilization when deployed in real-time, always-on scenarios. Fourth, when a user wishes to send a message to an animal or plant, conventional systems provide, at best, static actuations (for example, fixed light blinks or tones) that are not dynamically derived from the user's message content. There is no standardized internal representation (signal specification information) that systematically maps natural-language messages to low-level physical parameters for acoustic or light output. This prevents the processor from optimizing signal synthesis and delivery as a coherent computational task tied to prior analysis.

Moreover, when these functions are deployed continuously (for example, 24/7 acquisition and analysis), the lack of an integrated generative AI model that simultaneously handles multimodal sensor data, user prompt sentences, and long-term behavior patterns results in significant technical drawbacks: high inference latency due to repeated pre- and post-processing outside the model; increased main-memory traffic and inter-process communication; and difficulty in scheduling GPU workloads efficiently. The overall effect is that the underlying computer system cannot leverage hardware accelerators and memory hierarchies effectively, which limits scalability and responsiveness.

Accordingly, there is a need for a system and processor configuration that: (i) unifies acquisition, preprocessing, and multimodal fusion of acoustic and image information from non-verbal targets into analyzable time-series data; (ii) tightly integrates prompt sentence interpretation with generative AI model inference, so that user intent directly conditions state estimation and explanation; (iii) maintains and updates individual-specific behavior pattern models in a manner that is natively coupled with the generative AI model; and (iv) programmatically converts user messages into structured signal specification information that is efficiently translated into physical output signals. By addressing these issues at the level of processor configuration and data flow, the invention improves how computer systems perform multimodal analysis, natural-language-conditioned inference, and signal synthesis, thereby enhancing throughput, reducing latency, and enabling more adaptive real-time interaction with non-verbal entities.

The specific processing by the specific processing unit 290 of the data processing device 12 in Example 2 is realized by the following means.

The present invention provides a server comprising a processor configured to acquire acoustic information and image information from living organisms or other non-verbal targets via an input device including an imaging device and an acoustic acquisition device; to perform, on the acquired acoustic information, signal processing including at least noise reduction processing and frequency component extraction processing, and to perform, on the acquired image information, image processing including at least pixel conversion processing and motion enhancement processing so as to convert the acquired acoustic information and image information into analyzable time-series data; to analyze a prompt sentence input by a user through a terminal device, the prompt sentence instructing estimation or interpretation of a state or behavior of a non-verbal target, by classifying an intention type of the prompt sentence and determining an association condition between the prompt sentence and the analyzable time-series data; to execute, based on the time-series data and the prompt sentence, feature extraction processing, state estimation processing, and behavior pattern estimation processing by using a generative AI model implemented on a machine learning framework, thereby generating an analysis result including at least state information, request information, and behavior pattern information of the non-verbal target and generating, from the analysis result, a natural-language explanatory text and recommended action information; to transmit the analysis result and the explanatory text to the terminal device via a communication line so that the terminal device converts the analysis result and the explanatory text into a user-understandable display format; to acquire, from the user, a message including an intention to be transmitted to the non-verbal target, classify emotional content and instruction content of the message, and convert the message into signal specification information including a signal scheme and physical parameters according to a target type; to control, based on the signal specification information, an output device including at least an acoustic output device and a light output device so as to synthesize a physical signal defining at least one of frequency, amplitude, temporal pattern, and light-emission pattern and transmit the physical signal to the non-verbal target; and to store the analysis result and the signal specification information in association with time information in a storage device, and update an individual-specific behavior pattern model by performing learning or re-learning of the generative AI model based on accumulated data. This enables the server to integrate multimodal sensing, prompt-based intent interpretation, generative-model-based state estimation, and structured signal synthesis into a unified processing pipeline that reduces redundant computation, improves utilization of computational resources including accelerators, lowers end-to-end latency for real-time interaction, and enhances the accuracy and adaptability of communication with non-verbal targets.

The term “processor” refers to a hardware or virtual computing element, such as a central processing unit, graphics processing unit, or dedicated accelerator, that executes instructions to perform data acquisition, preprocessing, model inference, signal synthesis, communication, and storage control.

The term “living organism” refers to a biological entity such as an animal, plant, or microorganism that is capable of exhibiting behavior or physiological changes but does not natively use human natural language for communication.

The term “non-verbal target” refers to a living organism or other entity that does not communicate through human natural-language utterances, including animals, plants, unconscious patients, or artificial agents that lack verbal interfaces.

The term “input device” refers to any hardware component that converts physical phenomena into digital signals, including but not limited to imaging devices, acoustic acquisition devices, and environmental sensors.

The term “imaging device” refers to a hardware component, such as a camera or image sensor, that acquires optical information and outputs digital image or video data representing a field of view.

The term “acoustic acquisition device” refers to a hardware component, such as a microphone or acoustic sensor, that acquires sound waves and outputs digital audio data representing acoustic information.

The term “acoustic information” refers to digital data representing sound, including vocalizations, environmental noises, and other audio signals acquired from a non-verbal target or its surroundings.

The term “image information” refers to digital data representing visual content, including still images, video frames, or sequences of frames that capture a non-verbal target or its environment.

The term “signal processing” refers to computational operations applied to time-domain or frequency-domain data, such as filtering, noise reduction, normalization, and feature extraction, to transform raw signals into analyzable forms.

The term “noise reduction processing” refers to a signal processing operation that suppresses or removes unwanted components, such as background noise or sensor artifacts, from acoustic or other signals while preserving relevant information.

The term “frequency component extraction processing” refers to a signal processing operation that transforms a time-domain signal into a representation highlighting its spectral content, such as by computing a spectrum, spectrogram, or band-limited components.

The term “image processing” refers to computational operations applied to image or video data, such as resizing, color conversion, normalization, motion detection, or enhancement, to transform raw images into analyzable data.

The term “pixel conversion processing” refers to an image processing operation that changes the representation of image pixels, including at least resizing, color space conversion, or quantization, to produce a format compatible with subsequent analysis.

The term “motion enhancement processing” refers to an image processing operation that emphasizes temporal or spatial changes between frames, such as motion detection, background subtraction, or optical flow estimation, to highlight behavior of a non-verbal target.

The term “analyzable time-series data” refers to digital data structured as sequences indexed by time, including synchronized audio segments, image frames, and derived features, which are formatted for input to a statistical or machine learning model.

The term “terminal device” refers to an end-user computing device, such as a smartphone, tablet, personal computer, or dedicated display unit, that communicates with the server and presents information to a user and receives user inputs.

The term “prompt sentence” refers to a natural-language expression provided by a user that instructs the system to perform a certain type of analysis, estimation, or explanation regarding a non-verbal target.

The term “intention type” refers to a classification label that characterizes the functional purpose of a prompt sentence or message, such as a state inquiry, health inquiry, command, explanation request, or reassurance.

The term “association condition” refers to rule or parameter information that specifies how a prompt sentence is linked to corresponding time-series data, including selection of time windows, sensor modalities, or target identifiers.

The term “generative AI model” refers to a machine-learned model, such as a neural network configured for generative tasks, that produces outputs including inferred states, behavior patterns, explanations, or signal parameters based on input data and prompts.

The term “machine learning framework” refers to software infrastructure that implements numerical computation and training for machine learning models, including automatic differentiation, tensor operations, and model serialization.

The term “feature extraction processing” refers to a computational operation in which raw or preprocessed data are transformed into higher-level numerical representations that capture salient characteristics related to states or behaviors of a non-verbal target.

The term “state estimation processing” refers to an inference operation that outputs categorical or continuous values representing an internal or external condition of a non-verbal target, such as stress level, health state, or need state.

The term “behavior pattern estimation processing” refers to an inference operation that identifies or updates a representation of typical sequences of actions or responses exhibited by a non-verbal target over time.

The term “analysis result” refers to structured digital information generated by the system that includes at least state information, request information, and behavior pattern information derived from sensor data and prompt sentences.

The term “state information” refers to data indicating an inferred condition of a non-verbal target, such as thirsty, stressed, relaxed, active, or inactive, possibly with associated confidence values.

The term “request information” refers to data indicating an inferred need or desire of a non-verbal target, such as a need for water, food, rest, or environmental adjustment.

The term “behavior pattern information” refers to data indicating characteristic temporal sequences or trends in the behavior or responses of a non-verbal target, including statistical or learned representations of such patterns.

The term “natural-language explanatory text” refers to a human-readable text string, generated by the system, that describes in a natural language the inferred state, behavior, or recommendations regarding a non-verbal target.

The term “recommended action information” refers to data specifying one or more suggested operations for a user, such as watering a plant, changing environmental conditions, or initiating further observation, based on the analysis result.

The term “communication line” refers to any wired or wireless communication medium, including local and wide-area networks, that enables data transfer between the server and one or more terminal devices.

The term “user-understandable display format” refers to a representation of information, such as textual messages, icons, graphs, or other visual elements, that is configured to be easily interpreted by a human user.

The term “message” refers to natural-language content input by a user for the purpose of conveying an intention, emotion, or command to a non-verbal target through the system.

The term “emotional content” refers to that portion of a message that expresses affective information such as reassurance, encouragement, warning, or calmness.

The term “instruction content” refers to that portion of a message that specifies an action or desired response from a non-verbal target, such as a command or directive.

The term “signal scheme” refers to a logical description of how information is encoded into a physical signal, including modality selection such as sound, light, or vibration, and the patterning of that modality.

The term “physical parameters” refers to quantitative values defining characteristics of a physical signal, including at least frequency, amplitude, intensity, duration, and timing.

The term “signal specification information” refers to structured data that defines a signal scheme and associated physical parameters to be used for synthesizing a physical signal tailored to a particular target type or intent.

The term “output device” refers to any hardware component capable of emitting a physical signal, including at least acoustic output devices and light output devices controlled by the processor.

The term “acoustic output device” refers to a hardware component, such as a loudspeaker or ultrasonic emitter, that converts digital audio data into audible or inaudible sound waves.

The term “light output device” refers to a hardware component, such as a light-emitting element or display, that converts digital control signals into emitted light patterns.

The term “physical signal” refers to a time-varying physical phenomenon, such as sound, light, or vibration, that is generated under control of the system according to signal specification information.

The term “frequency” refers to a measure of how often a periodic component of a physical signal repeats per unit time, including acoustic frequency or modulation rate.

The term “amplitude” refers to a measure of the magnitude or intensity of a physical signal, such as sound pressure level or light intensity.

The term “temporal pattern” refers to an arrangement of signal values or events over time, including sequences of pulses, durations, intervals, and repetition schemes.

The term “light-emission pattern” refers to a temporal and spatial arrangement of light characteristics, such as color, brightness, and on-off timing, produced by a light output device.

The term “storage device” refers to a non-transitory computer-readable medium, such as a memory device or disk system, that stores digital data including analysis results, signal specification information, and model parameters.

The term “time information” refers to data that specifies a temporal attribute, such as a timestamp or time interval, associated with acquired data, analysis results, or emitted signals.

The term “individual-specific behavior pattern model” refers to a learned data structure or model instance that characterizes behavior patterns of a particular non-verbal target, distinct from models for other targets.

The term “learning” refers to an operation that updates parameters of a generative AI model or related models using training data, such as through optimization algorithms that minimize a loss function.

The term “re-learning” refers to an operation that retrains or fine-tunes a previously trained model using additional or updated data, including adaptation to a specific individual or environment.

The term “accumulated data” refers to collections of stored information, including historical time-series data, analysis results, and signal specification information, gathered over time by the system for one or more non-verbal targets.

The term “brain wave information” refers to digital data representing electrical activity of a brain, obtained through a sensor such as an electroencephalographic device.

The term “biological signal information” refers to digital data representing physiological activity, such as heart rate, muscle activity, or skin conductance, obtained through biosensors.

The term “non-verbal communication” refers to interaction between a user and a non-verbal target that is mediated by signals other than human natural-language speech, such as sound patterns, light patterns, or other stimuli.

The term “environmental information” refers to digital data representing conditions around a non-verbal target, including at least temperature, humidity, illumination, or other measurable environmental variables.

The term “neural network” refers to a computational model composed of interconnected nodes arranged in layers, which processes input data to produce outputs by applying learned parameters.

The term “long-term behavior pattern” refers to a representation of behavior or state changes of a non-verbal target observed over an extended period, capturing trends, periodicities, or persistent tendencies.

The term “state change trend” refers to a pattern describing how inferred states of a non-verbal target evolve over time, including directions, rates, or periodic changes in such states.

The server implements a non-verbal communication system by executing a program on general-purpose computing hardware, for example on a server computer including at least one central processing unit (CPU), one graphics processing unit (GPU), a main memory, a non-volatile storage device, and network interfaces. The server runs an operating system such as a general-purpose server operating system and executes application software implemented, for example, in a high-level programming language. The server uses software libraries and frameworks including a machine learning framework (for example, a deep learning framework), a numerical computation library (for example, a tensor library), an image processing library (for example, a computer vision library), an audio processing library, and communication middleware such as an HTTP server framework and a WebSocket library.

The terminal is implemented by a user device such as a smartphone, a tablet computer, or a personal computer, and executes an application that communicates with the server via a network. The terminal includes a display, a touch panel or keyboard, a microphone, a camera, and a network interface. The terminal runs an operating system such as a mobile operating system or a desktop operating system and executes application code written in, for example, an object-oriented language or a scripting language.

The user operates the terminal to initiate interactions with the server. The user, for example, launches an application, selects a target animal or plant from a list, and inputs a prompt sentence such as:
“What is this animal thinking right now?” “Please
tell me the health condition of this plant.” “Is
this plant asking for water?” “Why
is this dog barking repeatedly?” “What
does this cat want me to do?”

The terminal sends the prompt sentence, together with an identifier of the target and user preferences, to the server via a secure network connection.

The server controls an input device subsystem that includes at least one imaging device and at least one acoustic acquisition device. The server can use a universal serial bus camera, an internet protocol camera, or another image sensor as the imaging device, and a general-purpose microphone or microphone array as the acoustic acquisition device. The server receives raw image data through a video device driver interface and raw audio data through an audio device driver interface such as a low-level sound architecture or similar subsystem.

The server converts raw sensor outputs into analyzable time-series data by a predefined data-processing pipeline. The server, for example, samples audio signals at a fixed sampling rate (e.g., 16 kHz, 16-bit, mono) and stores them in buffers of a fixed length. The server applies digital signal processing operations, including band-pass filtering, spectral subtraction, and amplitude normalization, through an audio processing library. The server thereby generates noise-reduced, normalized audio waveforms. The server transforms the audio waveforms into spectrograms or mel-spectrograms by computing short-time Fourier transforms with specified window lengths and overlap factors, and then applies per-channel energy normalization. This produces two-dimensional arrays representing frequency versus time that are suitable as input tensors for a neural network.

The server acquires video frames at a predefined resolution and frame rate (for example, 1280×720 pixels at 30 frames per second). The server processes each frame using an image processing library. The server converts color formats to a standard format, resizes frames to a model-compatible resolution (for example, 224×224 pixels), and normalizes brightness and contrast. The server optionally performs motion enhancement processing by computing differences between consecutive frames, applying background subtraction, and calculating optical flow or motion vectors. The server thereby generates per-frame feature maps or motion masks that highlight leaf movements, body posture changes, or other behavior of the non-verbal target.

The server structures the processed audio and video data into unified time-series blocks. The server, for example, defines a 10-second time window and groups audio spectrogram segments and synchronized video frames into a data structure containing: (i) an audio tensor (time×frequency), (ii) an image tensor (time×height×width×channels), (iii) timestamp metadata, and (iv) target identifiers. The server stores these data structures in memory and, if needed, in a storage device for later retrieval. This explicit structuring of multimodal data reduces repeated preprocessing when multiple prompt sentences refer to the same time interval, thereby improving computational efficiency and reducing memory-bandwidth consumption.

The server interprets a prompt sentence using a natural-language understanding module that is implemented as a generative AI model. The server instantiates a language model based, for example, on a Transformer architecture with multiple self-attention layers, feed-forward layers, and token-embedding layers. The server tokenizes the prompt sentence into subword tokens using a tokenizer and maps the tokens to embedding vectors. The server processes the embeddings through the Transformer layers to produce a contextual representation of the prompt sentence. The server then applies a classification head to the representation to determine an intention type, such as “state inquiry,” “health inquiry,” “command,” or “explanation request.” The server further computes association conditions that specify which time windows, sensor modalities, and target identifiers should be used for analysis in response to the prompt sentence. For example, for “Is this plant asking for water?”, the server selects recent, longer-term image data and environmental data; for “Why is this dog barking repeatedly?”, the server prioritizes audio data and short-term motion features.

The server executes a multimodal generative AI model on a GPU by using a machine learning framework. In one embodiment, the server implements the generative AI model as a neural network having: (i) an audio encoder subnetwork, (ii) an image encoder subnetwork, (iii) a fusion network, and (iv) a decoder network for generating natural-language explanations. The audio encoder subnetwork may include convolutional layers followed by recurrent layers or self-attention layers to extract temporal acoustic features from spectrograms. The image encoder subnetwork may include a convolutional neural network or a vision-transformer-like architecture that outputs per-frame feature vectors. The fusion network may concatenate or attend across the audio and image features to produce a joint representation that captures correlations between vocalizations and movements. The decoder network may be a sequence-to-sequence Transformer that conditions on the joint representation and on an embedding of the prompt sentence, thereby generating textual tokens describing inferred states and behaviors.

The server feeds the time-series tensors and prompt-sentence embeddings into the generative AI model and performs forward inference. The server computes, for each batch, internal activations using matrix multiplications, non-linear activation functions, and attention-weighted combinations of features. The server outputs, for each non-verbal target, state labels (such as “thirsty,” “stressed,” “relaxed”), continuous scores (such as health indices or stress indices), and high-dimensional latent vectors representing individual-specific behavior patterns. The server uses a classification layer with a softmax function for state labels and a regression layer for continuous scores. The server combines the latent vectors with historical behavior pattern models, which are stored in a storage device, to update long-term behavior representations per individual.

The server generates natural-language explanatory text by using the decoder portion of the generative AI model configured for text generation. The server iteratively predicts tokens using the decoder's attention to the fused representation and the prompt-sentence embedding. The server applies decoding strategies such as beam search or temperature-controlled sampling. The server converts token sequences back into text strings using the tokenizer's inverse mapping. For example, when the prompt sentence is “Is this plant asking for water?”, the server can generate an explanatory text such as “This plant appears to want water. Its leaves are slightly drooping and the color is less vivid than usual.”

The server stores analysis results in a structured format, for example as objects in a database system. Each record can include: (i) target identifier, (ii) timestamp, (iii) state label, (iv) health score, (v) behavior-pattern vector, (vi) explanatory text, and (vii) recommended action text. The server aggregates records over time to compute long-term behavior patterns and state-change trends. The server can periodically retrain or fine-tune the generative AI model using accumulated data, applying supervised or semi-supervised learning schemes. The server can, for example, define a loss function that combines cross-entropy error for state classification, mean-squared error for continuous scores, and a reconstruction or contrastive loss for behavior-pattern embeddings. The server updates model weights through gradient-based optimization. This continuous learning mechanism allows the model to adapt to individual differences and environmental variations, thereby improving prediction accuracy and reducing error rates over time.

The server also manages user messages intended to be transmitted to non-verbal targets. The user enters a natural-language message such as “Please relax, everything is safe.” or “You will get water soon.” via the terminal. The terminal sends the message to the server. The server analyzes the message using the language model to separate emotional content and instruction content. The server classifies the message into categories such as reassurance, encouragement, warning, or instruction.

The server then selects a signal scheme and physical parameters appropriate for the target type. For example, for a dog, the server might select an acoustic signal scheme with low-frequency, soft tones in a slow pulsating temporal pattern; for a plant, the server might select a light-output scheme with moderate-intensity, slowly pulsing illumination.

The server converts the classified message into signal specification information, which encodes, for example, parameters such as carrier frequency, amplitude, envelope shape, pulse duration, repetition period, and color or brightness for light signals. The server synthesizes audio signals by generating sampled waveforms using numerical computation routines and applies digital envelopes (attack, decay, sustain, release) to control smoothness. The server sends the resulting buffers to an acoustic output device via an audio driver. For light signals, the server generates sequences of control values for light-emitting elements, including color codes and on/off timings, and sends them over a communication bus such as a serial bus or network protocol to a light output device. By defining an intermediate signal specification layer, the server decouples natural-language processing from low-level device control, which allows consistent optimization of both analysis and actuation and reduces redundant conversions when multiple devices share similar signal schemes.

The server, by executing these operations, does not merely automate a human observational task but improves the performance of the underlying computer system. The server reduces inference latency and memory usage by unifying multimodal preprocessing and by structuring data into reusable time-series blocks keyed by timestamps and target identifiers. The server improves accuracy and robustness by using a multimodal generative AI model that fuses audio and image features conditioned on prompt sentences, rather than applying separate, uncoordinated classifiers. The server improves resource utilization by offloading heavy tensor computations to a GPU and by batching multiple requests together based on association conditions derived from prompt sentences. These design choices increase throughput and reduce energy consumption relative to naive, sequential processing architectures.

The server achieves further technical effects by continuously updating individual-specific behavior pattern models. Because the server maintains latent representations in a consistent vector space, the server can perform incremental learning with relatively small mini-batches, reducing the need to reload large training datasets and thus reducing storage I/O load. The server can also cache frequently used model parameters and behavior patterns in main memory while offloading rarely used data to secondary storage, thereby optimizing memory hierarchy usage.

The terminal participates in the system by providing context-rich, low-latency interaction to the user.

The terminal displays explanatory texts and recommended actions with visual indicators. The terminal may present confidence scores, historical graphs, or icons generated from the analysis result. The terminal sends prompt sentences and messages to the server using compact, structured requests so that only necessary metadata and text are transmitted, reducing network traffic and communication latency. The terminal thus cooperates with the server to achieve a human interface that does not require the user to understand the underlying technical structure yet benefits from improved speed and accuracy.

The user interacts with the system in a manner that exploits the system's technical capabilities. The user can submit different prompt sentences for different analytical tasks, such as state inquiries, long-term health assessments, or explanations of specific behaviors. The user can observe that the system responds more quickly and consistently than manual observation, even under high data load, due to the server's optimized data pipeline and specialized generative AI model. The user can also send reassuring or instructive messages to non-verbal targets without manually configuring any audio or light patterns, because the server automatically computes and emits optimized signals through the output devices.

In alternative embodiments, the server can incorporate additional sensors such as environmental sensors (temperature, humidity, light level), contact sensors, or physiological sensors attached to animals or plants. The server can extend the generative AI model to include additional input branches that process these sensor streams. The server can also deploy different neural network architectures, such as recurrent neural networks, temporal convolutional networks, or graph neural networks, depending on the temporal structure of the data and the complexity of the target behaviors.

The server may run the language-understanding and multimodal-fusion components on separate processors or accelerator devices and coordinate them via high-speed interconnects.

In other embodiments, the server may prioritize low-power operation by dynamically adjusting sampling rates, model complexity, and batch sizes based on current system load and user requirements. The server can, for example, switch to a lightweight model variant when the network connection is constrained or when only coarse state information is required. By doing so, the server further reduces communication overhead and energy consumption while maintaining necessary functionality.

Through these configurations and variations, the server, terminal, and user cooperatively implement the claimed system. The described structures and operations allow a person skilled in the art to realize the invention using commercially available computing hardware, input devices, and output devices, as well as known software frameworks for machine learning, image processing, and audio processing. The system thereby provides concrete, technical improvements in how computers acquire, process, and act upon multimodal data and user prompt sentences in order to facilitate communication with non-verbal targets.

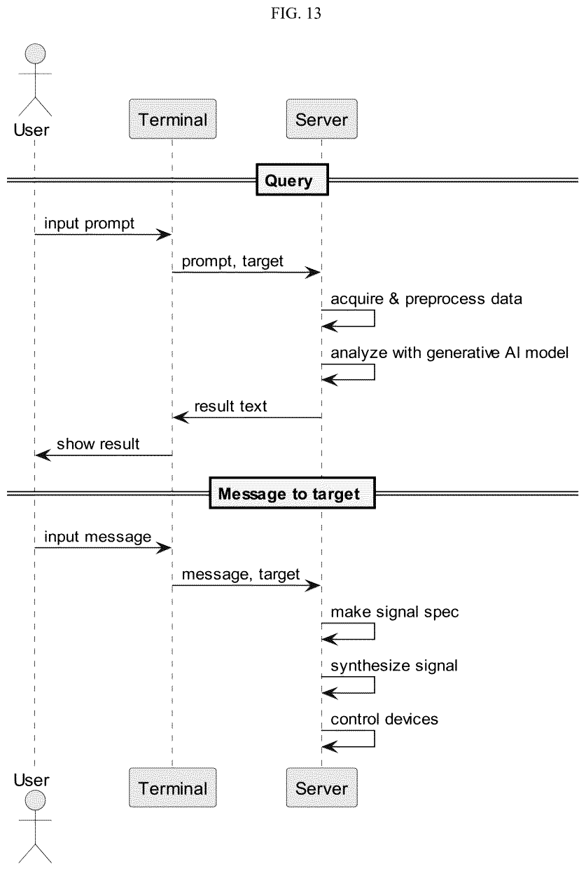

The following describes the processing flow using FIG. 13.

### Step 1:

The server initializes hardware and software resources.

The server sets up connections to imaging devices, acoustic acquisition devices, and output devices by invoking device drivers of the operating system. As input, the server receives configuration parameters such as sampling rates, frame resolutions, device identifiers, and model file paths. The server allocates buffers in main memory, loads a generative AI model and a language model into GPU memory via a machine learning framework, and initializes network listeners for connections from the terminal. As output, the server produces initialized device handles, pre-allocated data structures for time-series data, and in-memory model instances ready for inference.

### Step 2:

The server acquires raw sensor data from non-verbal targets.

The server periodically polls or passively receives image frames from the imaging device and audio samples from the acoustic acquisition device. As input, the server uses device handles, timing parameters, and trigger signals that specify when to capture data. The server reads audio into fixed-length buffers (for example, 16000 samples per second) and reads video frames at specified intervals (for example, 30 frames per second). The server timestamps each buffer and frame with synchronized clock values. As output, the server produces raw audio streams (arrays of sample values) and raw image frames (arrays of pixel values) tagged with time information and target identifiers.

### Step 3:

The server preprocesses audio data into normalized spectral representations.

The server receives raw audio buffers as input. The server applies digital filters such as band-pass filters to remove frequencies outside expected vocalization ranges, then performs noise reduction by estimating background noise and subtracting it in the spectral domain. The server computes short-time Fourier transforms over sliding windows to obtain spectrograms or mel-spectrograms and applies normalization across frequency bands. As output, the server produces two-dimensional arrays of normalized spectral coefficients for each time window, which form audio tensors suitable for input to the generative AI model.

### Step 4:

The server preprocesses image data into normalized frame tensors.

The server receives raw image frames with timestamps as input. The server converts color formats, resizes each frame to a fixed resolution compatible with the model, and adjusts brightness and contrast using histogram normalization or similar techniques. The server calculates frame differences or motion maps by subtracting consecutive frames or computing optical flow, then enhances motion regions by applying thresholds or masks. As output, the server generates image tensors (time×height×width×channels) and optional motion tensors aligned with corresponding audio segments.

### Step 5:

The server constructs unified time-series data blocks.

The server takes preprocessed audio tensors, image tensors, and timestamp metadata as input. The server aligns audio and video data by matching timestamps and slicing them into fixed-duration windows (for example, 10-second intervals). The server bundles, for each window, the audio tensor, the image tensor, and metadata including target identifier, time range, and sensor configuration. As output, the server produces structured time-series blocks stored in memory or temporary storage, each block representing multimodal observations suitable for joint analysis.

### Step 6:

The terminal collects a prompt sentence and target selection from the user.

The user operates the terminal interface to select a target (such as a specific animal or plant) and enters a prompt sentence through a text input field. As input, the terminal receives keystrokes or touch events and a current list of registered targets. The terminal converts the user actions into a textual prompt sentence such as “What is this animal thinking right now?” or “Please tell me the health condition of this plant.” The terminal then packages the prompt sentence, the target identifier, and user preference settings into a request object. As output, the terminal transmits this request object to the server via a network connection.

### Step 7:

The server interprets the prompt sentence and determines analysis conditions.

The server receives the request object containing the prompt sentence and target identifier as input.

The server tokenizes the prompt sentence and feeds token embeddings into a language-understanding model, which outputs an intention type (for example, state inquiry or health inquiry) and relevance scores for different data modalities and time ranges. The server uses these outputs to compute association conditions specifying which time-series blocks, sensors, and historical data segments to use. As output, the server produces an internal analysis plan including the selected time-series blocks and intent metadata to be used by the generative AI model.

### Step 8:

The server performs multimodal feature extraction using the generative AI model.

The server takes the selected time-series blocks and the encoded prompt sentence as input. The server passes audio tensors through an audio encoder network that applies convolution and attention operations to extract temporal acoustic features, and passes image tensors through an image encoder network that applies convolution or attention operations to extract visual features. The server combines audio and image feature vectors in a fusion network that computes joint representations conditioned on the prompt embedding. As output, the server produces fused feature representations that capture both multimodal observations and user intent.

### Step 9:

The server estimates states and behavior patterns of the non-verbal target.

The server uses fused representations from the generative AI model as input. The server applies classification layers with softmax activation to output probabilities over state categories (for example, “thirsty,” “relaxed,” “stressed”), and regression layers to output continuous scores such as health indices or stress levels. The server also updates a behavior-pattern embedding by combining the current fused representation with a stored historical embedding via operations such as weighted averaging or recurrent updates. As output, the server generates an analysis result object that includes state labels, scores, updated behavior-pattern vectors, and internal confidence values.

### Step 10:

The server generates a natural-language explanation based on the analysis result.

The server receives the analysis result object and the prompt sentence as input. The server feeds the fused representation, the behavior-pattern embedding, and the prompt embedding into a decoder network configured for text generation. The server iteratively predicts output tokens while attending to the input representations, using beam search or similar decoding methods to choose likely sequences. As output, the server produces a natural-language explanatory text such as “This plant appears to want water. Its leaves are slightly drooping and its color is less vivid than usual.”

### Step 11:

The server stores the analysis result and explanation for long-term use.

The server takes the analysis result object, explanatory text, and associated timestamps as input. The server converts these into a structured record containing fields for target identifier, time, state labels, scores, behavior-pattern vector, and text messages. The server writes the record to a storage device managed by a database system. As output, the server maintains a persistent history that can be retrieved for trend analysis, behavior-pattern learning, and answering future prompt sentences with context-aware information.

### Step 12:

The server sends analysis results and explanations to the terminal.

The server receives a display request from the terminal or uses the original prompt request as input.

The server packages the analysis result and explanatory text into a response message including formatted strings and numerical values. The server transmits the response to the terminal via a communication protocol. As output, the server provides the terminal with ready-to-display content reflecting the current state and behavior of the non-verbal target.

### Step 13:

The terminal displays the system response to the user.

The terminal receives the response message from the server as input. The terminal parses the message, extracts explanatory text, recommended actions, and optional numerical scores, and maps them into user interface elements such as text areas, icons, and charts. The terminal updates the screen so that the user sees a message such as “This plant wants water” along with visual indicators of health and recent behavior. As output, the terminal presents a human-readable interface that communicates the system's analysis to the user.

### Step 14:

The user enters a message intended for the non-verbal target.

The user reads the explanation on the terminal and decides to send a message to the target, such as “You will get water soon.” or “Please relax, everything is safe.” The terminal receives this new text input and associates it with the same target identifier. As input, the terminal takes user keystrokes or touch events and the current context. The terminal packages the user message and context into a new request object. As output, the terminal transmits this request to the server.

### Step 15:

The server converts the user message into signal specification information.

The server receives the user message and target context as input. The server uses a language model to classify the message's emotional content and instruction content and then selects an appropriate signal scheme (for example, acoustic, light, or combined). The server maps the classified content to quantitative parameters, such as target acoustic frequency range, amplitude level, pulse duration, repetition rate, light color, and brightness. The server encodes these parameters into a signal specification object describing how to generate the physical signal. As output, the server produces signal specification information that serves as a blueprint for device control.

### Step 16:

The server synthesizes physical signals based on the signal specification information.

The server takes the signal specification object as input. For acoustic signals, the server generates sampled waveforms by computing sinusoidal or shaped wave functions according to specified frequencies, amplitudes, and envelopes, then assembling them into a time-domain buffer of audio samples. For light signals, the server creates a timed sequence of color and intensity values per light-emitting element according to the temporal pattern defined in the specification. As output, the server generates concrete audio buffers and light-control sequences ready to be sent to output devices.

### Step 17:

The server controls output devices to emit the synthesized signals.

The server uses the generated audio buffers and light-control sequences as input. The server sends audio buffers to an acoustic output device via an audio driver interface, ensuring that sample rates and buffer sizes match the device capabilities. The server sends light-control commands over a control bus or network to a light output device, specifying timing and intensity changes. As output, the server causes sound waves and light patterns to be emitted in the physical environment near the non-verbal target, thereby delivering the user's message as a non-verbal signal.

### Step 18:

The server logs emitted signals and subsequent observations for feedback learning.

The server records the signal specification object, emission time, and target identifier as input data for logging. The server associates this log entry with subsequent sensor data and analysis results to evaluate how the non-verbal target responds. The server stores these entries in the database and may later use them as training data for updating the generative AI model, adjusting how messages are mapped to signal parameters. As output, the server maintains a feedback dataset that supports improved accuracy and efficiency in future signal synthesis and state estimation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”

Conventional computer systems that analyze biological sound, motion, environmental data, and biological signals typically employ isolated classification models and fixed rule sets. Such systems suffer from several technical limitations. First, they lack a unified internal representation that consistently maps heterogeneous sensor inputs (for example, sound, video, and biosignals) into a structured semantic layer, causing inconsistency and latency when generating explanations for end users. Second, existing systems generally invoke machine-learned models with static, hard-coded queries, without dynamically constructing model inputs (prompts) that reflect the current multi-modal context; as a result, the computing resources of generative AI models are underutilized and inference quality is unstable.

Third, conventional systems treat natural-language explanation, alert generation, and bidirectional communication with organisms as separate application-level functions implemented on the client side, which leads to duplicated logic, fragmented state management, and increased network traffic.

The server often returns only low-level scores or labels, leaving terminals to perform additional formatting, thresholding, and adaptation, thereby increasing client-side processing load and introducing inconsistent behavior across terminals.

Fourth, even when user biological signals and affective cues are available, they are rarely integrated into the core inference pipeline. The system does not adapt model inputs, explanation style, or notification modality based on the user's current emotional state, leading to suboptimal human-computer interaction and inefficient use of bandwidth and compute cycles for non-critical notifications. Similarly, facility-wide monitoring systems for consciousness and emotional anomalies often rely on simple threshold logic on the edge, without centrally generated, context-rich natural-language alerts produced in a standardized way.

Fifth, typical architectures do not support a closed-loop mechanism in which the server not only interprets organism states but also synthesizes organism-directed signal patterns, using the same internal language system and generative AI pipeline. As a consequence, separate signaling subsystems must be engineered, and model outputs cannot be consistently reused to drive output devices such as loudspeakers or actuators.

Accordingly, there is a need for an improved computer-implemented system and server architecture that: (i) integrates multi-modal sensor preprocessing and feature extraction into a unified feature space; (ii) constructs and updates an internal language system mapping biological behavior patterns and biosignals to linguistic meanings; (iii) automatically generates context-aware prompt sentences for a generative AI model on the server; (iv) centrally produces user-adapted natural-language explanations, alerts, and organism-directed signal patterns; and (v) reduces overall client-side complexity, network overhead, and inconsistency while improving the technical performance and scalability of the AI-based communication pipeline.

The specific processing by the specific processing unit 290 of the data processing device 12 in Application Example 2 is realized by the following means.

The present invention provides a server comprising a processor configured to acquire biological sound information, biological motion information, environmental information, and biological signal information from sensors and terminal devices; to preprocess the acquired information by digital signal processing to generate normalized, time-aligned feature data; to learn, using machine learning including neural networks, relationships among biological behavior patterns, physiological states, and environmental conditions, and to construct and update internal language system information associating such behavior patterns with linguistic meanings; to parse a prompt sentence received from a user and, based on a content of the prompt sentence, the internal language system information, and the feature data, automatically generate a model-oriented prompt sentence; to input the model-oriented prompt sentence and the feature data to a generative AI model and obtain natural-language explanation information or response instruction information regarding a state or emotional state of an organism; to format the obtained information into display information or audio information and transmit the formatted information to a terminal device; to receive a user message directed to an organism as a prompt sentence and, using the internal language system information and the generative AI model, convert the user message into an organism-oriented signal pattern and output an acoustic signal or physical stimulation signal corresponding to the signal pattern; to estimate a user emotional state from user sound information, user facial information, and user biological signal information, and to dynamically adjust at least one of an expression style and a notification method of the explanation information or the response instruction information according to the estimated emotional state; and to calculate, from biological signal information of monitored subjects, an abnormality degree of at least one of a consciousness state and an emotional state, to generate an internal alert-oriented prompt sentence for the generative AI model, to cause the generative AI model to generate alert information explaining abnormal content in a natural language, and to transmit the alert information to the terminal device. This enables a unified, server-centric AI processing pipeline that reduces client-side computation and network overhead, improves the consistency and quality of natural-language outputs from the generative AI model, adapts explanations and alerts to the user's emotional state, and efficiently supports both interpretation of organism states and synthesis of organism-directed signals within a single optimized computer architecture.

The term “biological sound information” refers to data representing acoustic signals produced by living organisms, including but not limited to vocalizations, body-movement sounds, and other audible emissions, acquired as digital audio signals from one or more sensing devices.

The term “biological motion information” refers to data representing physical movements or postures of living organisms, acquired as time-series image or sensor data from one or more imaging devices or motion sensors.

The term “environmental information” refers to data representing physical or chemical conditions of an environment surrounding a subject, including, for example, temperature, humidity, illumination, noise level, and similar measurable environmental parameters.

The term “biological signal information” refers to data representing physiological activities of a subject, including but not limited to brain electrical activity, cardiac activity, respiratory activity, or other biosignals measured by medical or wearable devices.

The term “digital signal processing” refers to computational operations performed on digitized signals, including at least one of filtering, noise reduction, normalization, resampling, segmentation, feature extraction, and similar numerical transformations.

The term “feature data” refers to structured numerical or symbolic values derived from raw sensor data by preprocessing, which are formatted for input to one or more machine-learning models or pattern-recognition algorithms.

The term “time-aligned feature data” refers to feature data from different modalities that are associated with common or synchronized temporal indices such that features corresponding to a same time interval can be jointly processed.

The term “behavior pattern” refers to a recurring combination of motions, sounds, or other observable outputs of an organism that can be recognized as a pattern and used for classification or inference.

The term “physiological state” refers to an internal physical condition of an organism, including, for example, arousal level, fatigue level, pain level, or similar internal states that can be inferred from biosignals or behaviors.

The term “internal language system information” refers to data structures stored in a memory that associate one or more behavior patterns and physiological indicators with corresponding linguistic meanings, semantic labels, or symbolic representations used for interpretation and generation.

The term “linguistic meaning” refers to a semantic concept or label expressible in a natural language, such as “hungry,” “stressed,” or “relaxed,” which is associated with one or more patterns in sensor data.

The term “prompt sentence” refers to a text string received from a user or generated internally, which expresses a request or instruction for a machine-learning model, including a generative AI model.

The term “model-oriented prompt sentence” refers to a prompt sentence that has been transformed or augmented by a processor so as to include structured context, feature summaries, or constraints suitable for input to a generative AI model.

The term “generative AI model” refers to a machine-learning model configured to generate output data, including natural-language text, based on an input sequence, context, or prompt, and implemented using at least one of neural networks or probabilistic models.

The term “explanation information” refers to natural-language text or equivalent structured data describing an inferred state, emotional state, or condition of an organism or subject in a form understandable by a human user.

The term “response instruction information” refers to natural-language text or equivalent structured data that recommends or specifies an action or response to be taken with respect to an organism, subject, or environment.

The term “terminal device” refers to an information-processing apparatus separate from the server, such as a portable device, a stationary client device, or a display device, configured to send data to and receive data from the server.

The term “organism-oriented signal pattern” refers to a representation of one or more output signals, such as acoustic or physical stimuli, that are determined to be appropriate for communicating information to an organism based on the internal language system information.

The term “acoustic signal” refers to a signal that, when converted by an actuator such as a speaker, produces sound waves in a propagation medium and is intended to be perceived by an organism.

The term “physical stimulation signal” refers to a control signal for an actuator that generates a non-acoustic stimulus, such as light, vibration, or mechanical motion, intended to be perceived by an organism.

The term “user sound information” refers to audio data representing voice or other sounds produced by a user, acquired by at least one microphone and processed by the system.

The term “user facial information” refers to image or video data representing a user's face, including facial expressions or movements, acquired by at least one imaging device.

The term “user biological signal information” refers to biosignal data associated with a user, including but not limited to heart-rate data, brainwave data, or similar physiological measurements.

The term “user emotional state” refers to an internal affective condition of a user, such as joy, anger, fear, calmness, or stress, as estimated by processing user sound information, user facial information, and/or user biological signal information.

The term “expression style” refers to characteristics of natural-language output, including tone, politeness level, level of technical detail, length, and similar stylistic parameters used when presenting explanation information or response instruction information.

The term “notification method” refers to a manner in which information is delivered to a user via a terminal device, including at least one of visual display, audio output, haptic feedback, priority level, or repetition frequency.

The term “monitored subject” refers to any individual or organism whose biological signal information is acquired and analyzed by the system within a facility, including a patient, an occupant, or an animal.

The term “abnormality degree” refers to a quantitative or qualitative measure indicating a deviation of at least one of a consciousness state or an emotional state from a reference or normal range, as computed from biological signal information.

The term “alert-oriented prompt sentence” refers to a model-oriented prompt sentence that summarizes detected abnormal conditions and instructs a generative AI model to generate alert information in a natural language.

The term “alert information” refers to natural-language text or equivalent structured data indicating the presence, type, and possible severity of an abnormal condition, intended to be communicated to a user via a terminal device.

The term “care-receiving subject who lacks voluntary consciousness” refers to an individual in a medical or care environment whose ability to voluntarily express intentions or emotions is substantially reduced or absent, and whose state is inferred from biosignals.

The term “organism state estimation model” refers to a machine-learning model configured to infer one or more states of an organism, such as behavior category or physiological condition, from feature data.

The term “machine learning processing using a neural network” refers to a training or inference procedure in which a neural-network-based model adjusts parameters or computes outputs based on input feature data, using algorithms such as gradient-based optimization or forward propagation.

In one embodiment, a server implements the claimed system as a network-connected computing apparatus comprising at least one processor, a main memory, a non-volatile storage device, a network interface, and interfaces for external sensors and actuators. The server executes software modules implemented, for example, in a general-purpose programming language with numerical libraries (such as Python with libraries including NumPy, SciPy), signal-processing libraries (such as librosa), and image-processing libraries (such as OpenCV). The server additionally executes machine-learning frameworks (such as TensorFlow or PyTorch) and a client for accessing an external generative AI model via a network-based application programming interface. The server further cooperates with one or more terminal devices, which may be smartphones, tablets, or wearable devices, each comprising a processor, a display, a microphone, a camera, and optionally biosignal sensors or interfaces to external biosignal sensors.

The server acquires biological sound information and environmental noise information from microphones, and biological motion information from cameras or other imaging devices, through analog-to-digital converters or digital interfaces such as USB, RTSP, or wireless protocols. The server acquires biological signal information, such as brainwave signals or cardiac signals, from medical or wearable devices via standardized protocols such as Bluetooth Low Energy, serial communication, or network protocols. The terminal acquires user sound information via a built-in microphone, user facial information via a built-in camera, and, in some configurations, user biological signal information from local sensors or connected wearables, and transmits these data to the server through secure network connections.

The server stores the acquired raw data in structured repositories. For example, the server stores audio streams as sequences of fixed-length frames with timestamps, video streams as images with frame indices and timestamps, and biosignals as multichannel time-series arrays. The server organizes these data in time-aligned structures, such as key-value records in a database or serialized tensor arrays, so that heterogeneous modalities can be jointly processed. By representing multimodal inputs in a unified internal format, the server reduces data duplication and minimizes synchronization errors across modalities, improving downstream processing efficiency.

The server performs digital signal processing on the acquired information by executing dedicated preprocessing modules. The server applies band-pass and notch filters, implemented using numerical routines, to audio and biosignal data to remove line noise and sensor artifacts. The server computes spectrograms and mel-frequency cepstral coefficients for audio signals, and computes frame-level motion vectors and region-of-interest crops for image data using optical-flow algorithms and object-detection models implemented in the machine-learning framework. The server normalizes each feature dimension using precomputed statistics (for example, mean and variance) so that different sensors and recording conditions can be handled in a common feature space. This normalization significantly reduces the variance introduced by sensor differences and improves the accuracy and convergence speed of the downstream machine-learning models.

The server constructs feature data as multidimensional arrays comprising, for example, temporal windows of audio features, motion features, environmental values, and biosignal features. The server stores each window with an associated metadata structure indicating the organism identity, sensor configuration, and environmental context. The server uses this feature representation as input to an organism state estimation model implemented as a neural-network architecture. In one embodiment, the server implements a model including a convolutional neural-network front end for spatial or spectral feature extraction, followed by a recurrent neural network or transformer blocks for temporal pattern modeling, and a final fully connected layer that outputs probability distributions over behavior patterns, physiological states, or emotional states.

The server trains the organism state estimation model using supervised and semi-supervised learning techniques. The server defines an objective function, such as cross-entropy loss over labeled behavior categories and physiological states, and performs gradient-based optimization to update the model parameters. The server optionally performs data augmentation, such as adding noise to audio data, random cropping or flipping of image patches, and jittering of biosignal segments, to increase the robustness of the model to real-world variations. By executing training on large-scale historical feature data, the server derives model parameters that are tuned to the specific multimodal characteristics of biological sound, motion, and biosignals, yielding improved recognition accuracy compared to generic models.

The server additionally maintains internal language system information as a structured database linking model outputs and feature patterns to linguistic meanings. In one embodiment, the server stores, for each learned behavior pattern or biosignal pattern, a set of semantic labels, associated confidence levels, and contextual conditions (such as environmental thresholds or co-occurring behaviors). The server periodically updates this database by aggregating recent inference results, user feedback, and any ground-truth annotations. This internal language system information provides a stable intermediate representation that decouples low-level sensor data from high-level natural-language descriptions, thereby improving modularity and enabling efficient reuse of the same learned associations across different output tasks.

The server receives a prompt sentence from a user through a terminal device, for example via a text input field or speech-to-text interface. Example prompt sentences include “Analyze the barking of this dog from the last 30 seconds and describe its emotion in English,” “Analyze this patient's EEG data over the last 10 minutes and estimate the current consciousness state,” “Analyze the following lion's roar recording and output its emotion as English text,” and “Analyze the EEG and heart-rate data below and detect any abnormal consciousness or emotional states.” The terminal transmits the prompt sentence and a reference to relevant data segments to the server.

The server parses the prompt sentence using a natural-language processing component, which may be implemented, for example, using a lightweight parser or a local language-understanding model.

The server extracts intent information (such as “emotion analysis” or “consciousness estimation”), target entities (such as “dog” or “patient”), and temporal constraints (“last 30 seconds,” “last 10 minutes”). Using this parsed structure, the server retrieves the corresponding feature data windows and internal language system information. The server then constructs a model-oriented prompt sentence that embeds both the user request and a compressed representation of the relevant context.

In one embodiment, the server generates a model-oriented prompt sentence such as: “User question:

‘Analyze the barking of this dog from the last 30 seconds and describe its emotion in English.’ System context: The audio analysis shows rapid, high-pitched barks with short intervals, body posture leaning forward, and tail slightly lowered. Please provide a concise explanation of the dog's emotion for a non-expert user.” The server accomplishes this by applying deterministic formatting rules and by summarizing numerical feature values and model outputs into human-readable descriptors using mapping tables derived from the internal language system information. This explicit and structured prompting enables the generative AI model to focus on higher-level semantic reasoning rather than low-level pattern recognition, improving the consistency and quality of generated text.

The server communicates with a generative AI model implemented either locally within the server or on a remote computing resource. The server provides the model-oriented prompt sentence and, when appropriate, additional structured data (such as key-value pairs of state labels and confidence scores) through a programmatic interface. The generative AI model, for example an autoregressive language model, generates natural-language explanation information or response instruction information. The server receives the generated text and post-processes it by enforcing constraints on length, vocabulary, or format, and by inserting identifiers or metadata suitable for terminal presentation.

The server also receives, as prompt sentences, user messages directed to organisms. For example, the user may input “I will feed you soon, please wait calmly” targeting a dog, “We will water you shortly” targeting a plant, or “When the user's emotion is ‘joy,’ how should communication with animals and plants be adjusted?” The server combines these user messages with current organism state estimates and internal language system information to construct translation-oriented prompt sentences for the generative AI model, such as “Translate the following human message into an appropriate signal pattern for a hungry dog based on the learned language system: ‘I will feed you soon, please wait calmly.” The generative AI model returns a description of an organism-oriented signal pattern, for example a specification of sound frequency ranges, durations, and temporal structure, or a specification of light or vibration patterns.

The server converts the organism-oriented signal pattern into concrete actuator commands. In the case of acoustic output, the server uses digital audio synthesis algorithms to generate waveforms meeting the specified parameters, then transmits the audio data to a speaker connected to the server or to a networked audio device. In the case of physical stimulation signals, the server generates control messages for lighting systems, vibration actuators, or similar devices. Because the server bases these output patterns on its internal language system and multimodal state estimates, the system executes closed-loop communication with organisms that is technically coordinated and repeatable, rather than ad hoc or manually designed.

The terminal acts primarily as an interface device. The terminal displays explanation information and alert information as text, icons, or simple graphs, and, in some embodiments, plays back audio messages generated by the server. The terminal also captures user reactions and optional feedback, such as confirmations or corrections of inferred organism states. The server logs this feedback and uses it during subsequent training cycles to refine its models and internal language system information, thereby continually improving accuracy and reducing error rates over time.

The server further estimates a user emotional state by processing user sound information, user facial information, and user biological signal information. The server may use a separate neural-network model trained on multimodal human affective data. For example, the server can implement a fusion model that concatenates acoustic features, facial expression embeddings, and biosignal features, and outputs probability distributions over emotional categories. The server then selects an expression style and notification method based on the estimated emotional state. For instance, if the user is estimated to be stressed or angry, the server selects a calmer, more concise style and may reduce the frequency of non-critical alerts, thereby reducing cognitive load on the user. This adaptive notification mechanism is implemented as a rule-based or learned policy in the server and directly influences the formatting and routing of generative AI model outputs.

For facility-wide monitoring, the server continuously receives biological signal information from multiple monitored subjects and computes anomaly scores using models such as autoencoders or statistical detectors. When the anomaly score exceeds a threshold, the server constructs an alert-oriented prompt sentence, for example: “The heart-rate of subject X increased from 70 bpm to 140 bpm within 30 seconds, and brainwave data shows elevated high-frequency power. Generate an alert message for security staff in simple English.” The generative AI model generates alert information, such as “A sudden increase in heart rate suggests severe stress or panic. Please check on this person immediately.” The server then transmits this alert information to appropriate terminal devices. By centralizing this anomaly detection and alert generation, the server reduces redundant processing on terminals and ensures that alerts are expressed consistently and with appropriate detail.

The described architecture provides several technical improvements over conventional systems. Because the server constructs time-aligned feature data and maintains internal language system information, it reduces the need for terminals to perform complex synchronization or interpretation, thereby decreasing computation and memory usage on resource-constrained devices. The use of model-oriented prompt sentences, which embed structured context and precomputed features, improves the computational efficiency of the generative AI model by reducing the need for the model to infer low-level details from raw, unstructured inputs. This reduces the number of tokens and processing steps required during inference, leading to lower latency and lower network bandwidth consumption.

The server's neural-network architectures and training procedures are selected to exploit the particular statistical structure of multimodal biosignal and behavior data. For example, by using temporal attention mechanisms on top of convolutional encoders, the server can focus computation on salient time intervals, thereby improving both accuracy and computational efficiency. By using targeted loss functions that incorporate both classification accuracy and calibration of confidence scores, the server better distinguishes between normal and abnormal states, reducing false positives and false negatives in alert generation. The continuous learning loop, in which the server retrains its models with new labeled and pseudo-labeled data, improves robustness to sensor drift and population changes.

The system improves computer technology itself rather than merely automating a human decision process. The server introduces a non-conventional dataflow and control scheme in which heterogeneous sensory inputs are transformed into a unified feature space, mapped to semantic representations via an internal language system, and then fed into generative AI processes through dynamically constructed prompt sentences. This architecture reduces the number of independent data representations and interfaces that must be maintained, thereby simplifying memory management and caching strategies within the server. Furthermore, by offloading most semantic reasoning to server-side components and by adapting output formatting to user state, the system reduces redundant communication and computation, enabling more scalable deployment in environments with many sensors and users.

Alternative embodiments may vary specific implementation details while preserving the core architecture. For example, the server may implement the generative AI model entirely on-premises rather than through an external service; may use alternative neural-network architectures such as graph neural networks for modeling relationships among multiple organisms; or may employ different anomaly-detection algorithms for biosignals. The terminal may be a head-mounted display, a vehicle-mounted device, or an industrial control panel. The sensors may include additional modalities such as thermal imaging or chemical sensors, which are integrated into the same feature data structures. In all such embodiments, the server remains responsible for acquiring and preprocessing multimodal data, constructing internal language system information, generating model-oriented prompt sentences, invoking a generative AI model, and producing both human-oriented natural-language outputs and organism-oriented signal patterns in a technically coordinated manner.

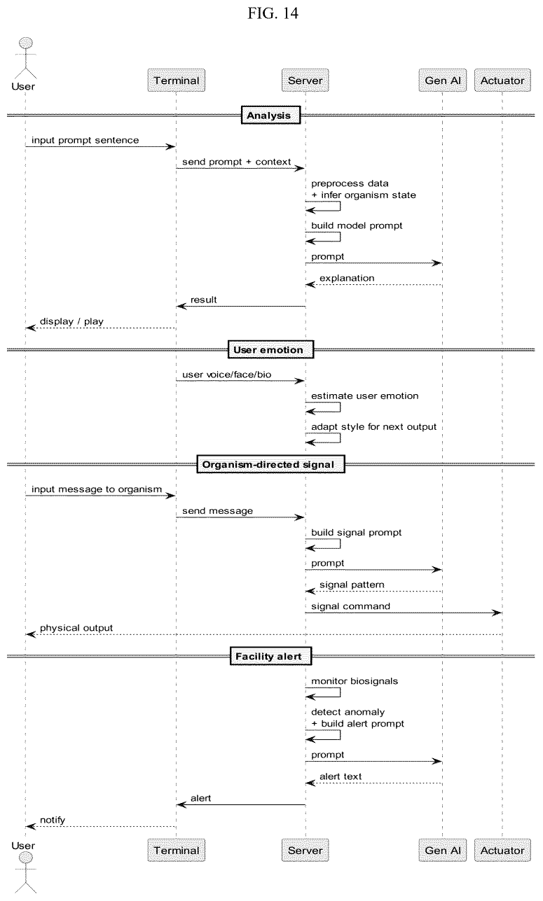

The following describes the processing flow using FIG. 14.

### Step 1:

The server acquires raw sensor data from the environment. The input is biological sound information from microphones, biological motion information from cameras, environmental information from environmental sensors, and biological signal information from medical or wearable devices. The server reads audio samples through audio drivers, reads video frames through an image-capture interface, reads environmental values via sensor APIs, and reads biosignals via communication interfaces such as Bluetooth or TCP/IP. The server outputs time-stamped raw data streams and stores them in memory or a database as sequences of audio buffers, image frames, environmental records, and biosignal samples.

### Step 2:

The terminal acquires user-side data and forwards them to the server. The input is user sound information captured by the terminal microphone, user facial information captured by the terminal camera, and, optionally, user biological signal information acquired from local sensors or connected wearables. The terminal uses operating-system APIs to sample audio and video, compresses them if necessary, and encapsulates the sampled data in network messages. The terminal outputs structured messages containing the user-side data and transmits them via a secure network connection to the server.

### Step 3:

The server preprocesses the acquired raw data into feature data. The input is the time-stamped raw data streams from Step 1 and Step 2. The server applies digital signal processing operations, including filtering, resampling, segmentation, and normalization. For audio and biosignals, the server computes spectrograms, mel-frequency cepstral coefficients, and band-power measures; for images, the server computes motion vectors and region-of-interest crops; for environmental data, the server interpolates and normalizes sensor readings. The server outputs time-aligned feature tensors and associated metadata describing organism identity, sensor configuration, and environmental context.

### Step 4:

The server estimates organism states from the feature data. The input is the feature tensors describing biological sound information, biological motion information, environmental information, and biological signal information. The server feeds these tensors into an organism state estimation model, which is implemented as a neural network with convolutional, recurrent, and/or attention layers. The server performs forward propagation through the model to compute probabilities over behavior patterns, physiological states, and emotional states. The server outputs structured organism state information that contains labels such as “hunger,” “stress,” or “relaxed,” together with confidence scores and timestamps.

### Step 5:

The server updates internal language system information. The input is the organism state information from Step 4 and the corresponding feature patterns. The server aggregates repeated co-occurrences of particular patterns and semantic labels, updates statistical counts and mapping tables, and adjusts association weights between feature clusters and linguistic meanings. The server may execute a learning algorithm such as incremental gradient updates or expectation-maximization on stored mapping parameters. The server outputs updated internal language system information that more accurately associates behavior patterns and biosignals with linguistic meanings.

### Step 6:

The user provides a prompt sentence through the terminal. The input is a natural-language request entered via a keyboard, touch interface, or speech-to-text component on the terminal, such as “Analyze the barking of this dog from the last 30 seconds and describe its emotion in English,” or

“Analyze this patient's EEG data over the last 10 minutes and estimate the current consciousness state.” The terminal encapsulates the text as a prompt sentence, attaches identifiers for the relevant organism or subject, and specifies a time range. The terminal outputs a prompt-sentence message and sends it to the server.

### Step 7:

The server parses the prompt sentence and retrieves relevant context. The input is the prompt-sentence message from Step 6. The server uses a parsing module to extract an analysis intent, target entities, and time constraints from the prompt sentence. The server queries its datastore for feature data and organism state information corresponding to the specified entity and time interval. The server outputs a set of context records, including selected feature tensors, organism state summaries, and applicable internal language system entries.

### Step 8:

The server constructs a model-oriented prompt sentence for a generative AI model. The input is the user prompt sentence from Step 6 and the context records from Step 7. The server summarizes numerical feature values and state labels into concise, human-readable descriptors and embeds them in a formatted description. The server concatenates the user request and the summarized context into a structured text, for example: “User question: ‘Analyze the barking of this dog from the last 30 seconds and describe its emotion in English.’ System context: The audio analysis shows rapid, high-pitched barks with short intervals, body posture leaning forward, and tail slightly lowered. Please provide a concise explanation of the dog's emotion for a non-expert user.” The server outputs this model-oriented prompt sentence as plain text.

### Step 9:

The server invokes the generative AI model with the model-oriented prompt sentence. The input is the model-oriented prompt sentence from Step 8 and, optionally, structured context fields. The server sends this input through an application programming interface to a generative AI model that has been configured to generate natural-language responses. The generative AI model performs internal sequence processing and returns a natural-language answer describing the organism's state or providing response instructions. The server outputs the received answer as explanation information or response instruction information.

### Step 10:

The server formats the explanation information for terminal presentation. The input is the explanation information or response instruction information from Step 9. The server applies formatting rules to enforce maximum length, remove disallowed terms, and insert identifiers or severity levels. The server converts the text into a structured representation that may include title text, body text, icons, and optional audio content. The server outputs formatted display information and, where configured, synthesized audio data.

### Step 11:

The terminal presents the formatted information to the user. The input is the display information and optional audio data from Step 10. The terminal renders the text on its display using user-interface components and, if audio is present, plays the audio through a speaker. The terminal may also display visual indicators such as color-coded icons or graphs based on severity levels or confidence scores. The terminal outputs a user-perceivable presentation of the organism state or recommended actions.

### Step 12:

The user optionally provides feedback or follow-up instructions. The input is the rendered explanation on the terminal from Step 11. The user may acknowledge the explanation, correct a misinterpreted state, or issue a new request such as “The dog is now wagging its tail slowly. What does that mean?” The terminal captures this feedback or follow-up as additional prompt sentences or structured feedback items. The terminal outputs the new information and sends it to the server for logging and further processing.

### Step 13:

The server estimates a user emotional state and adapts notification style. The input is user sound information, user facial information, and user biological signal information obtained in Step 2, together with recent user interactions and explanations. The server extracts features from these user data, such as voice pitch, facial expression vectors, and heart-rate variability, and feeds them into a user-emotion estimation model. The server computes probabilities for different emotional categories and selects a dominant user emotional state. Based on this state, the server adjusts parameters for subsequent explanations, such as choosing shorter, calmer messages for stressed users or more detailed messages for relaxed users. The server outputs updated notification configuration data that influence future formatting in Step 10.

### Step 14:

The user sends a message directed to an organism as a prompt sentence. The input is a text message such as “I will feed you soon, please wait calmly,” “We will water you shortly,” or “When the user's emotion is ‘joy,’ how should communication with animals and plants be adjusted?” entered on the terminal. The terminal records the target organism or class of organisms and forwards the message as a prompt sentence to the server. The terminal outputs a message-prompt packet including the text and target identifiers.

### Step 15:

The server generates an organism-oriented signal pattern from the user message. The input is the message-prompt packet from Step 14 and current organism state information and internal language system information from earlier steps. The server constructs a translation-oriented model-oriented prompt sentence, for example: “Translate the following human message into an appropriate signal pattern for a hungry dog based on the learned language system: ‘I will feed you soon, please wait calmly.” The server sends this prompt sentence to the generative AI model and receives a description of an organism-oriented signal pattern, such as recommended sound frequencies, durations, and temporal sequence. The server outputs a structured signal-pattern specification.

### Step 16:

The server synthesizes actuator commands from the organism-oriented signal pattern. The input is the signal-pattern specification from Step 15. For acoustic output, the server uses digital audio synthesis routines to generate a waveform matching the specified frequency and temporal pattern; for physical stimulation, the server creates control sequences for lights, vibration motors, or other actuators. The server encapsulates the generated data in device-specific command messages. The server outputs actuator commands and transmits them to the corresponding hardware devices.

### Step 17:

The terminal or external device executes the actuator commands in the physical environment. The input is the actuator commands from Step 16. The terminal, if equipped with an appropriate actuator, or an external controller connected to the server, converts the commands into low-level signals such as audio playback, light modulation, or mechanical vibration. The terminal or external device outputs physical stimuli that are perceivable by the targeted organism, thereby completing a closed-loop communication initiated by the user.

### Step 18:

The server monitors facility-wide biosignals and generates alerts when abnormalities occur. The input is continuous biological signal information from multiple monitored subjects within a facility.

The server segments the biosignals into windows, computes statistical features and anomaly scores using models such as autoencoders or outlier detectors, and compares the scores to predefined thresholds. When an abnormality is detected, the server constructs an alert-oriented prompt sentence, for example: “The heart-rate of subject X increased from 70 bpm to 140 bpm within 30 seconds, and EEG shows elevated high-frequency power. Generate an alert message for staff in simple English.” The server sends this prompt sentence to the generative AI model and receives alert information in natural language. The server outputs alert display information and transmits it to terminals associated with responsible users.

### Step 19:

The terminal notifies users of detected anomalies. The input is the alert display information from Step 18. The terminal displays the alert text prominently on its screen, may highlight the affected subject or location, and may play an alarm sound or trigger haptic feedback. The terminal outputs a high-priority notification that prompts the user to take investigative or corrective action.

### Step 20:

The server logs interactions and updates models and mappings over time. The input is all prior data, including raw sensor streams, feature data, organism state information, user prompt sentences, generative AI model outputs, user feedback, and alert outcomes. The server stores these data in persistent storage, samples batches for training, and periodically retrains the organism state estimation model, the user-emotion model, and the internal language system mapping parameters using machine-learning algorithms. The server computes updated parameters, evaluates performance metrics, and deploys improved models for subsequent inference. The server outputs refined models and mapping tables that enhance future recognition accuracy, response quality, and system responsiveness.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

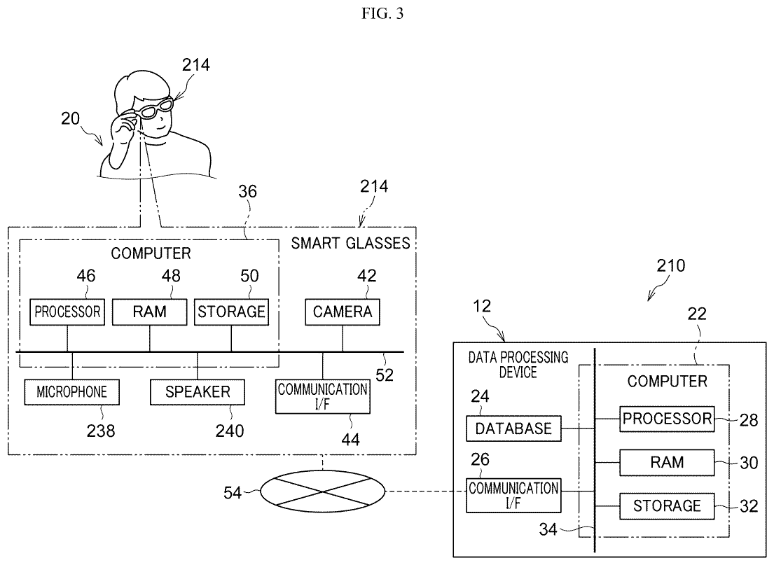

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

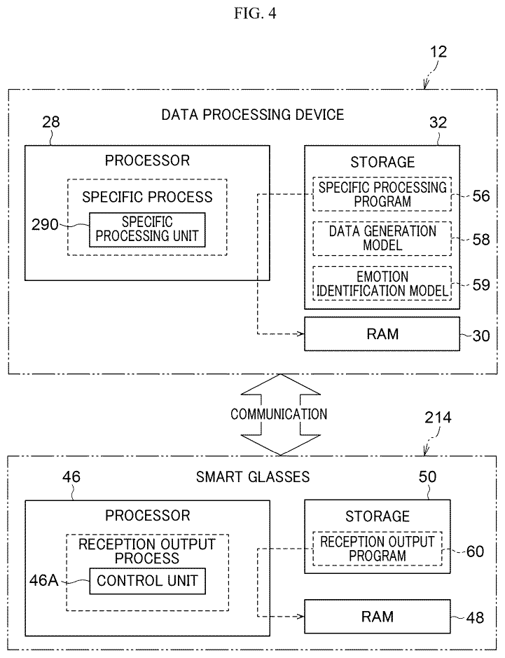

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

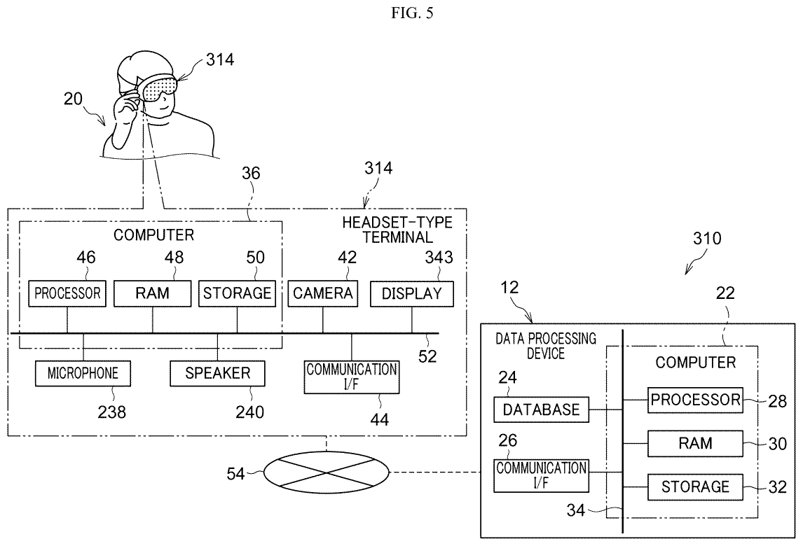

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

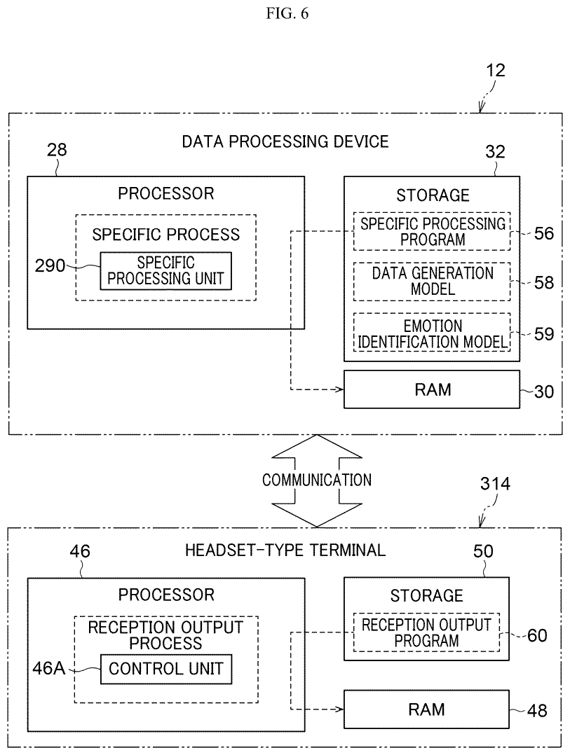

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

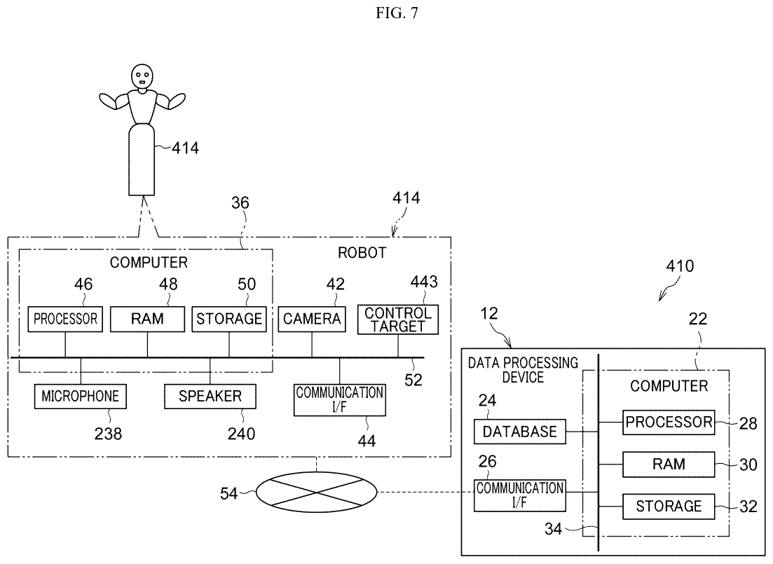

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

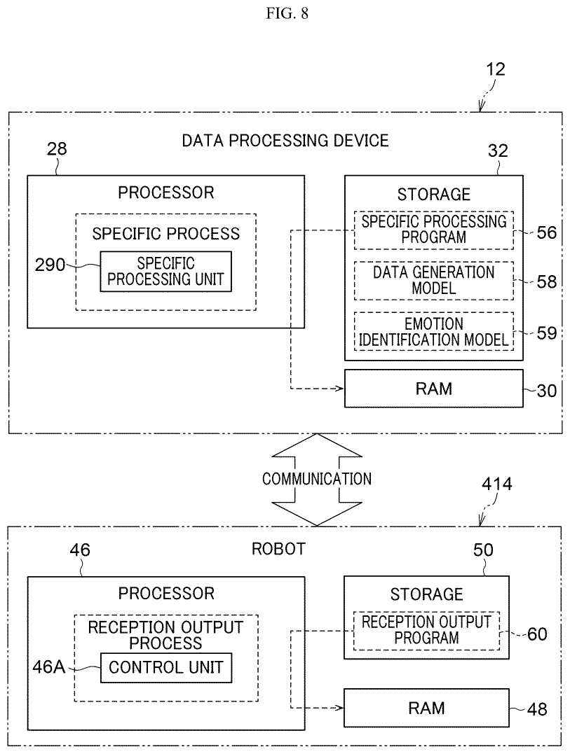

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

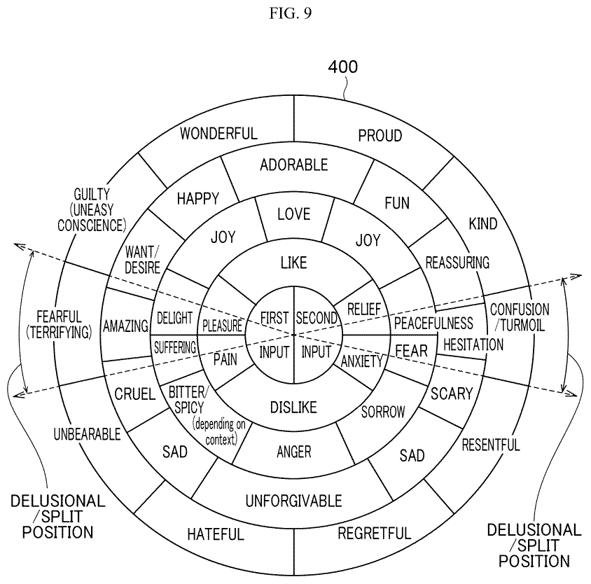

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

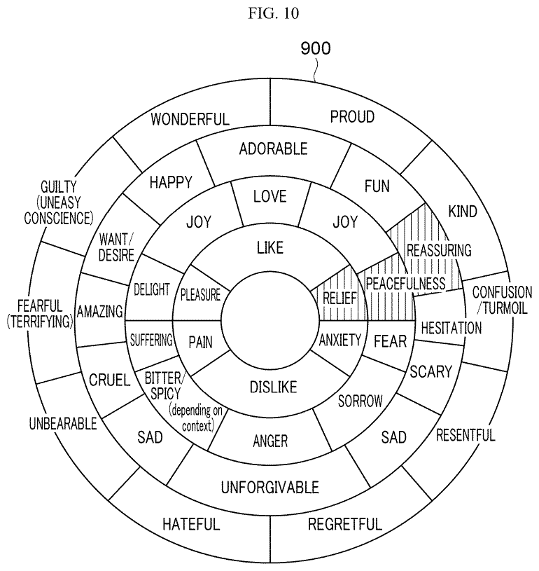

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire sound information, image information, and environmental information related to an organism from an input apparatus including an imaging apparatus and an acoustic collection apparatus, on a continuous basis, and record the acquired information in association with time information and target identification information,
preprocess the acquired sound information by executing, by a signal processing program, sampling, normalization, noise reduction, and conversion into a frequency-domain representation to output a two-dimensional numerical array, and preprocess the acquired image information by executing, by an image processing program, decoding, pixel count conversion, color space conversion, and
background separation to output a time-series image sequence, thereby generating a feature sequence representing behavior of the organism,
input the feature sequence generated by the preprocessing into an identification model including a machine learning model for time-series data analysis, classify or cluster a behavior pattern of the organism based on the feature sequence, and construct or update, in a storage unit, language system information describing a correspondence relationship between the behavior pattern and state information indicating an internal state or intention,
receive, from a user terminal, a prompt sentence including an interrogative sentence regarding a state of the organism, and analyze the prompt sentence to extract a target, a time range, and a question intention included in the prompt sentence,
acquire the behavior pattern and the language system information corresponding to the extracted target and time range, generate context information describing a current or past state of the target using the behavior pattern and the language system information, and generate a composite prompt sentence by combining the context information with the prompt sentence, and
input the composite prompt sentence into a generative artificial intelligence model, cause the generative artificial intelligence model to estimate the state of the organism based on the language system information, generate an answer sentence in natural language including a result of the estimation, and output the generated answer sentence to the user terminal.

### (Supplementary 2)

The system according to supplementary 1,
wherein the processor is configured to
acquire brain wave information and biometric signal information related to an unconscious person from the input apparatus, convert the brain wave information and the biometric signal information into a time-series feature sequence by the preprocessing, extract a behavior pattern or a state pattern corresponding to the feature sequence by the identification model, and register, in the language system information, a correspondence relationship between the state pattern and meaning information enabling communication, thereby enabling communication with the unconscious person via the generative artificial intelligence model.

### (Supplementary 3)

The system according to supplementary 1,
wherein the processor is configured to
execute, continuously or at a predetermined period, acquisition of the sound information, the image information, and the environmental information, generation of the feature sequence by the preprocessing, analysis of the behavior pattern by the identification model, and updating of the language system information, and, when the prompt sentence is input from the user terminal, generate the composite prompt sentence using a latest analysis result and the language system information and cause the generative artificial intelligence model to generate the answer sentence on demand.

### Application Example 1

### (Supplementary 1)

A system comprising a processor,
wherein the processor is configured to
acquire bioacoustic information, motion information, and environmental information of living organisms and plants,
preprocess the acquired bioacoustic information, motion information, and environmental information to convert the acquired information into a multidimensional feature vector including image features, acoustic features, and environmental features,
use the multidimensional feature vector as input to a machine learning model to learn a reference model representing a normal state of the living organisms and the plants, and evaluate a health state of the living organisms and the plants and calculate an abnormality degree on the basis of a reconstruction error or a similarity with respect to the reference model,
construct a language system that associates an internal state and an environmental state of the living organisms and the plants with human-readable descriptions on the basis of the abnormality degree and the multidimensional feature vector,
analyze a prompt sentence input from a user, the prompt sentence instructing estimation or explanation of the state of the living organisms and the plants, generate an input text including the prompt sentence, the abnormality degree, and the multidimensional feature vector, and provide the input text to a generative AI model so as to generate a natural-language answer sentence relating to the state of the living organisms and the plants,
determine environmental adjustment content for maintaining or improving the health state of the living organisms and the plants on the basis of an evaluation result of the health state or the natural-language answer sentence generated by the generative AI model, and generate a control command representing the environmental adjustment content, and
transmit the control command to an environment control apparatus or a work machine so as to cause execution of a physical environmental adjustment operation including at least one of water supply, temperature adjustment, humidity adjustment, illumination adjustment, and noise reduction, and thereafter reacquire the state of the living organisms and the plants and repeat the evaluation of the health state and the determination of the environmental adjustment content to perform feedback control.

### (Supplementary 2)

The system according to supplementary 1,
wherein the processor is configured to
acquire brain activity signals and biological signals, preprocess the acquired brain activity signals and biological signals to convert the acquired signals into a feature vector, convert the feature vector into a format acceptable to the generative AI model, estimate an internal state of a human in a non-responsive plant-like state on the basis of the feature vector, and generate a natural-language answer sentence relating to the internal state by using the language system and the generative AI model of supplementary 1.

### (Supplementary 3)

The system according to supplementary 1,
wherein the processor is configured to
continuously collect, at predetermined time intervals, the bioacoustic information, the motion information, and the environmental information of the living organisms and the plants, and at least one of the brain activity signals and the biological signals of supplementary 2, and periodically perform relearning or additional learning of the machine learning model and the generative AI model so as to update the reference model and the language system.

### Example 2

### (Supplementary 1)

A system comprising a processor,
wherein the processor is configured to
acquire acoustic information and image information from living organisms or other non-verbal targets by using an input device including an imaging device and an acoustic acquisition device, and perform signal processing including noise reduction processing and frequency component extraction processing on the acquired acoustic information and image processing including pixel conversion processing and motion enhancement processing on the acquired image information so as to convert the acquired acoustic information and image information into analyzable time-series data, and analyze a prompt sentence, which is input from a user via a terminal device and instructs estimation or interpretation of a state or behavior of the living organism or the non-verbal target, classify an intention type of the prompt sentence, and determine an association condition between the prompt sentence and the acquired time-series data, and
execute, based on the time-series data and the prompt sentence, feature extraction processing, state estimation processing, and behavior pattern estimation processing by using a generative artificial intelligence model configured on a machine learning framework, and generate an analysis result including state information, request information, and behavior pattern information of the living organism or the non-verbal target, and generate a natural-language explanatory text and recommended action information based on the analysis result, and
transmit the analysis result and the explanatory text to the terminal device via a communication line, and cause the terminal device to convert the analysis result and the explanatory text into a display format understandable to the user, and
acquire a message including an intention to be transmitted to the living organism or the non-verbal target, the message being input by the user, classify emotional content and instruction content of the message, and convert the message into signal specification information including a signal scheme and physical parameters according to a target type, and
control an output device including an acoustic output device and a light output device based on the signal specification information to synthesize a physical signal defining at least one of frequency, amplitude, temporal pattern, and light-emission pattern, and transmit the physical signal to the living organism or the non-verbal target, and
store the analysis result and the signal specification information in association with time information in a storage device, and update an individual-specific behavior pattern model by performing learning or re-learning of the generative artificial intelligence model based on accumulated data.

### (Supplementary 2)

The system according to supplementary 1,
wherein the processor is configured to acquire brain wave information and biological signal information from a target individual having a low level of consciousness, and analyze time-series data including the brain wave information and the biological signal information by using the generative artificial intelligence model so as to enable non-verbal communication with the target individual.

### (Supplementary 3)

The system according to supplementary 1,
wherein the processor is configured to continuously acquire, over a temporally continuous period, acoustic information, image information, and environmental information from the living organism or the non-verbal target, and perform learning of the continuously acquired information by using a neural network including the generative artificial intelligence model so as to update a long-term behavior pattern and a state change trend.

### Application Example 2

### (Supplementary 1)

A system comprising a processor,
wherein the processor is configured to
acquire biological sound information, biological motion information, and environmental information, and acquire biological signal information from a subject,
preprocess the acquired biological sound information, biological motion information, environmental information, and biological signal information by digital signal processing to convert the acquired information into analyzable feature data normalized in a time-series direction and per type, learn, on the basis of the feature data, a relationship among biological behavior patterns, physiological states, and surrounding environment, and construct and update internal language system information in which the biological behavior patterns are associated with linguistic meanings,
analyze a prompt sentence input from a user, and, on the basis of a content of the prompt sentence, the internal language system information, and the feature data, automatically generate a model-oriented prompt sentence to be input to a generative AI model,
input the model-oriented prompt sentence and the feature data to the generative AI model, and cause the generative AI model to generate explanation information in a natural language or response instruction information relating to a state or an emotional state of an organism,
format the explanation information or the response instruction information obtained from the generative AI model into display information or audio information presentable to the user, and
output the display information or the audio information to a terminal device,
receive, as the prompt sentence, a message from the user directed to an organism, and, by using the internal language system information and the generative AI model, convert the message into a signal pattern for the organism and output an acoustic signal or a physical stimulation signal corresponding to the signal pattern,
estimate an emotional state of the user on the basis of at least one of user sound information, user facial information, and user biological signal information, and dynamically adjust at least one of an expression style and a notification method of the explanation information or the response instruction information according to the estimated emotional state, and
calculate an abnormality degree of at least one of a consciousness state and an emotional state on the basis of biological signal information acquired from a monitored subject in a facility, generate an internal alert-oriented prompt sentence for the generative AI model, cause the generative AI model to generate alert information that explains abnormal content in a natural language, and transmit the alert information to the terminal device.

### (Supplementary 2)

The system according to supplementary 1,
wherein the processor is configured to input biological signal information for consciousness level evaluation, as the preprocessed feature data, to the generative AI model, estimate in a natural language at least one of a consciousness state and an emotional state of a care-receiving subject who lacks voluntary consciousness, and present the estimation to the terminal device.

### (Supplementary 3)

The system according to supplementary 1,
wherein the processor is configured to continuously acquire the biological sound information, the biological motion information, the environmental information, and the biological signal information, accumulate the information as the feature data, and periodically or continuously update the internal language system information and an organism state estimation model by machine learning processing using a neural network.

What is claimed is:

1. A system comprising:
circuitry configured to:
acquire, via sensor devices coupled to a communication interface, acoustic data, image data, and environmental data related to an organism on a continuous or periodic basis;
preprocess the acoustic data by performing sampling, normalization, noise reduction, and frequency-domain conversion to generate acoustic feature sequences, and preprocess the image data by performing decoding, resolution conversion, color-space conversion, and background separation to generate image feature sequences;
input the acoustic feature sequences and the image feature sequences into an identification model comprising a machine learning model for time-series data analysis, and classify or cluster behavior patterns of the organism based on the feature sequences;
construct and update, in a storage device, language system data encoding correspondence relationships between the behavior patterns and state data indicative of internal states of the organism;
receive, from a terminal device, a prompt sentence comprising an interrogative sentence regarding a state of the organism, parse the prompt sentence to extract at least a target identifier, a time range, and a question intention;
acquire, from the storage device, one or more behavior patterns and corresponding portions of the language system data matching the extracted target identifier and time range, and generate context data describing a current or past state of the target;
generate a composite prompt data structure by combining the context data with the prompt sentence according to a predetermined prompt template; and
transmit the composite prompt data structure to a generative neural network model to cause the generative neural network model to estimate the state of the organism based on the language system data and generate an answer sentence in natural language, and output the answer sentence to the terminal device.

2. The system according to claim 1,
wherein the circuitry is further configured to apply the machine learning model to multidimensional feature vectors comprising the acoustic feature sequences, the image feature sequences, and environmental feature data to learn and maintain a reference model representing a normal state of the organism, and evaluate a health state and calculate an abnormality degree based on a reconstruction error or similarity with respect to the reference model.

3. The system according to claim 2,
wherein the circuitry constructs the language system data by associating internal states and environmental states of the organism with human-readable descriptions based on the abnormality degree and the multidimensional feature vectors.

4. The system according to claim 2,
wherein the circuitry is further configured to determine environmental adjustment content based on the health state evaluation, generate a control command representing the environmental adjustment content, transmit the control command to an environment control apparatus to cause execution of a physical adjustment operation, reacquire state data of the organism after the adjustment, and repeat the evaluation and the determination to perform feedback control.

5. The system according to claim 1,
wherein the circuitry is further configured to perform, on the acoustic data, signal processing comprising noise reduction and frequency component extraction, and perform, on the image data, image processing comprising pixel conversion and motion enhancement, to convert the acoustic data and the image data into analyzable time-series data.

6. The system according to claim 5,
wherein the circuitry analyzes the prompt sentence by classifying an intention type and determining an association condition between the prompt sentence and the time-series data, and executes feature extraction, state estimation, and behavior pattern estimation by using the generative neural network model to generate an analysis result comprising state data, request data, and behavior pattern data, and generates from the analysis result a natural-language explanatory text and recommended action data.

7. The system according to claim 6,
wherein the circuitry is further configured to acquire, from the terminal device, a message comprising an intention to be transmitted to the organism, classify emotional content and instruction content of the message, and convert the message into signal specification data comprising a signal scheme and physical parameters according to a target type.

8. The system according to claim 7,
wherein the circuitry controls, based on the signal specification data, an output device comprising at least one of an acoustic output device and a light output device to synthesize a physical signal defining at least one of frequency, amplitude, temporal pattern, and light-emission pattern, and transmit the physical signal to the organism.

9. The system according to claim 7,
wherein the circuitry stores the analysis result and the signal specification data in association with time data in the storage device, and updates an individual-specific behavior pattern model by performing learning of the machine learning model based on accumulated data.

10. The system according to claim 1,
wherein the circuitry is further configured to acquire biological signal data from sensors associated with a monitored subject, preprocess the biological signal data by digital signal processing to generate normalized time-aligned feature data, and learn relationships among behavior patterns, physiological states, and environmental conditions using a neural network.

11. The system according to claim 10,
wherein the circuitry parses a prompt sentence from a user and, based on the prompt sentence, the language system data, and the feature data, automatically generates a model-oriented prompt data structure, transmits the model-oriented prompt data structure and the feature data to the generative neural network model, and obtains natural-language explanation data regarding a state of the monitored subject.

12. The system according to claim 11,
wherein the circuitry is further configured to receive a user message directed to the monitored subject, convert the user message using the language system data and the generative neural network model into a subject-oriented signal pattern, and output an acoustic signal or physical stimulation signal corresponding to the signal pattern via an output device.

13. The system according to claim 11,
wherein the circuitry is further configured to estimate a user emotional state from at least one of user acoustic data, user facial data, and user biological signal data, and dynamically adjust at least one of an expression style and a notification method of the explanation data according to the estimated user emotional state.

14. The system according to claim 10,
wherein the circuitry calculates, from the biological signal data, an abnormality degree of at least one of a consciousness state and an emotional state of the monitored subject, generates an alert-oriented prompt data structure for the generative neural network model, causes the generative neural network model to generate alert data explaining abnormal content in natural language, and transmits the alert data to the terminal device.

15. The system according to claim 1,
wherein the predetermined prompt template comprises placeholder fields for the context data, the target identifier, the time range, and the question intention, and the circuitry populates each placeholder field with corresponding extracted data to generate the composite prompt data structure.

16. The system according to claim 1,
wherein the circuitry continuously collects the acoustic data, the image data, and the environmental data over extended time periods, and periodically retrains the identification model and the language system data based on the continuously collected data to adapt to individual differences and temporal changes in organism states.

17. The system according to claim 1,
wherein the environmental data comprises at least temperature data, humidity data, and illumination data acquired from environmental sensors, and the circuitry incorporates the environmental data into the multidimensional feature vectors used by the identification model.

18. A system comprising:
circuitry configured to:
acquire acoustic data, image data, and environmental data related to an organism from sensor devices via a communication interface;
preprocess the acoustic data and the image data to generate feature sequences, and input the feature sequences into a machine learning model to classify behavior patterns;
construct language system data encoding correspondence between the behavior patterns and state data of the organism;
receive a prompt sentence from a terminal device, parse the prompt sentence, acquire matching behavior patterns and language system data, and generate a composite prompt data structure;
transmit the composite prompt data structure to a generative neural network model to generate an answer sentence regarding the state of the organism; and
output the answer sentence to the terminal device.

19. The system according to claim 18,
wherein the circuitry is further configured to acquire biological signal data from a monitored subject, calculate an abnormality degree, generate an alert-oriented prompt data structure, and cause the generative neural network model to generate alert data in natural language.

20. A method comprising:
acquiring, by circuitry via sensor devices, acoustic data, image data, and environmental data related to an organism;
preprocessing the acoustic data and the image data to generate feature sequences, and inputting the feature sequences into a machine learning model to classify behavior patterns;
constructing language system data encoding correspondence between the behavior patterns and state data of the organism;
receiving a prompt sentence from a terminal device, parsing the prompt sentence, acquiring matching behavior patterns and language system data, and generating a composite prompt data structure;
transmitting the composite prompt data structure to a generative neural network model to generate an answer sentence regarding the state of the organism; and
outputting the answer sentence to the terminal device.
